(19) United States
(12) Patent Application Publication
(10) Pub. No.: US 2024/0205908 A1
(43) Pub. Date: Jun. 20, 2024

(54) PHYSICAL DOWNLINK CONTROL CHANNEL (PDCCH) MONITORING FOR CROSS-CARRIER SCHEDULING

(71) Applicant: Intel Corporation, Santa Clara, CA (US)

(72) Inventors: Yingyang Li, Beijing (CN); Yi Wang, Beijing (CN); Debdeep Chatterjee, San Jose, CA (US); Gang Xiong, Portland, OR (US); Seunghee Han, San Jose, CA (US)

(21) Appl. No.: 18/550,093

(22) PCT Filed: May 23, 2022
(86) PCT No.: PCT/US2022/030539

§ 371 Date: Sep. 11, 2023

Related U.S. Application Data
(60) Provisional application No. 63/193,487, filed on May 26, 2021.
(60) Provisional application No. 63/246,653, filed on Sep. 21, 2021.
(60) Provisional application No. 63/250,175, filed on Sep. 29, 2021.
(60) Provisional application No. 63/322,154, filed on Mar. 21, 2022.

(51) Int. Cl. H04W 72/12; H04W 72/23

(52) U.S. Cl. CPC H04W 72/12; H04W 72/23

(57) ABSTRACT

Various embodiments may relate to physical downlink control channel (PDCCH) monitoring in association with cross-carrier scheduling. In particular, some embodiments are directed to scheduling a transmission on a primary cell (PCell) or primary secondary cell (PSCell) considering secondary cell (SCell) dormancy switching or SCell activation states. Other embodiments may be disclosed or claimed.

### CROSS REFERENCE TO RELATED APPLICATION

The present application claims priority to U.S. Provisional Patent Application No. 63/193,487, which was filed May 26, 2021; U.S. Provisional Patent Application No. 63/246,653, which was filed Sep. 21, 2021; U.S. Provisional Patent Application No. 63/250,175, which was filed Sep. 29, 2021; and to U.S. Provisional Patent Application No. 63/322, 154, which was filed Mar. 21, 2022.

### FIELD

Various embodiments generally may relate to the field of wireless communications. For example, some embodiments may relate to physical downlink control channel (PDCCH) monitoring in association with cross-carrier scheduling. In particular, some embodiments are directed to scheduling a transmission on a primary cell (PCell) or primary secondary cell (PSCell) considering secondary cell (SCell) dormancy switching or SCell activation states.

### BACKGROUND

The fifth generation (5G) new radio (NR) system is introduced in the third-generation partnership project (3GPP) as the evolution of fourth generation/long-term evolution (4G/LTE) to provide wider bandwidth and to support larger amount of traffic, extreme high reliability and low latency, etc. Though it is expected that 5G networks will finally replace 4G networks, there is a period of coexistence between 5G and 4G systems. For example, a 5G carrier may be a neighbor of a 4G carrier. A 5G carrier may also partially or fully overlap in frequency domain with a 4G carrier. Therefore, efficient support of coexistence between 5G and 4G system, e.g. dynamic spectrum sharing (DSS) is important to address during the period of 5G system deployment. Embodiments of the present disclosure address these and other issues.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of an SCell activation procedure in accordance with various embodiments.

FIG. 2 illustrates an example of common maximum BD/CCEs handling in accordance with various embodiments.

FIG. 3 illustrates an example of change on maximum BD/CCEs when SCell is deactivated in accordance with various embodiments.

FIG. 4 illustrates an example of a timeline to change the maximum BD/CCEs handling when sSCell is deactivated in accordance with various embodiments.

FIG. 5 illustrates an example of a timeline to change the maximum BD/CCEs handling when sSCell is dormant in accordance with various embodiments.

FIG. 6 schematically illustrates a wireless network in accordance with various embodiments.

FIG. 7 schematically illustrates components of a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 9, 10, and 11 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

DSS was considered since NR Rel-15. For example, a CRS pattern can be configured for

NR UE, so that the PDSCH transmission of a NR carrier could be rate matched around the REs potentially used by LTE CRS, which mitigates the impact to LTE channel estimation for better LTE DL performance. For example, NR transmission should be avoided on the resource used by LTE PDCCH. The consideration of LTE CRS/PDCCH causes limitation on the NR PDCCH transmissions. Therefore, it was proposed to support that a PDCCH of SCell could schedule PDSCH and/or PUSCH transmissions of PCell.

Carrier aggregation (CA) is one of the main schemes to increase data rate from system perspective and UE perspective. Though the key motivation is high data rate, energy efficiency is also a critical metric. When there are high traffics, new SCells may be added and activated for a UE. On the other hand, when there is no much remaining traffic, a SCell may be deactivated for the UE. As defined in TS 38.213, v. 16.4.0, 2021 Jan. 8, when a UE receives in a PDSCH with a MAC CE for activation of a SCell in slot n, the UE applies the corresponding actions in TS 38.321, v. 16.3.0, 2021 Jan. 6, no later than the minimum requirement defined in TS 38.133, v. 17.0.0, 2021 Jan. 12, and no earlier than slot n+k, except for the following:
the actions related to CSI reporting on a serving cell that is active in slot n+k
the actions related to the sCellDeactivation Timer associated with the secondary cell TS 38.321 that the UE applies in slot n+k
the actions related to CSI reporting on a serving cell which is not active in slot n+k that the UE applies in the earliest slot after n+k in which the serving cell is active.

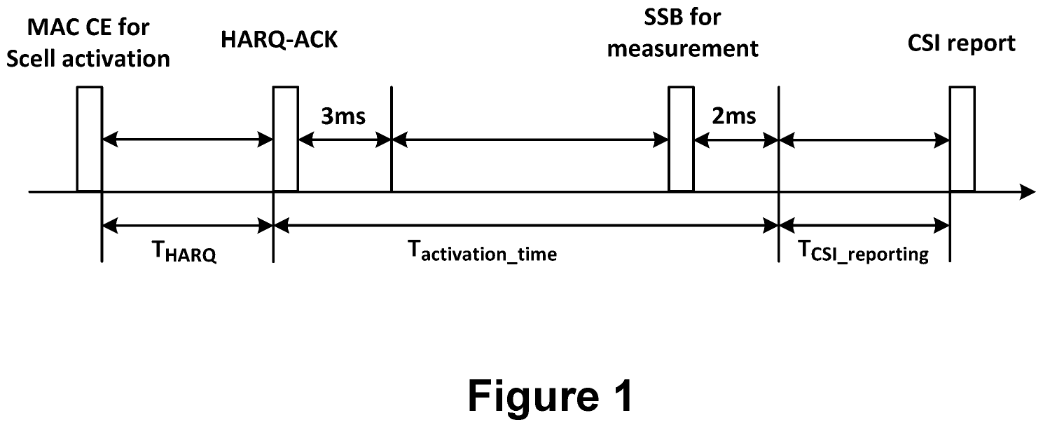

The value of k is k₁+3Nₛₗₒₜ^{subframeμ}+1 where slot n+k₁ is a slot indicated for PUCCH transmission with HARQ-ACK information for the PDSCH reception and Nₛₗₒₜ^{subframe,μ} is a number of slots per subframe for the SCS configuration μ of the PUCCH transmission as defined in TS 38.211. As illustrated in FIG. 1, The UE shall have completed the activation at latest by slot n+T_{HARQ}+T_{activation_time}+T_{CSI_Reporting}. T_{HARQ} is the timing between DL data transmission and acknowledgement, e.g., k₁ as defined above. T_{activation} time includes the delay of MAC-CE parsing time, RF warm up, AGC settling and frequency/time synchronization. T_{CSI_reporting} is the delay including uncertainty of the timing of CSI-RS transmission, UE processing time for CSI reporting and uncertainty of UL resource for CSI feedback. The main contribution on delay to the SCell activation delay comes from the T_{activation_time.}

Further, in MR-DC & eCA WI in NR Rel-16, SCell dormancy behavior was introduced. If there is no much traffic, an activated SCell could be switched into a dormant BWP to save power, which also allow a quick switching into non-dormant BWP right after more traffics arrive. The dormancy behavior is supported based on BWP framework. That is, at least two BWPs are configured on a SCell. One BWP is the dormant BWP which is configured without PDCCH monitoring. Further, typically long cycle of CSI reporting is configured on the dormant BWP. The other BWP(s) is/are configured for normal data transmission, e.g. non-dormant BWP(s) for which normal PDCCH monitoring and normal CSI reporting are configured.

The SCell dormancy switching can be triggered by DCI format 0_1 or 1_1 when a PUSCH or a PDSCH is scheduled by the DCI, which is Case 1 Scell dormancy indication. Further, a DCI format 1_1 also supports to trigger SCell dormancy switching without scheduling a PDSCH, which is Case 2 Scell dormancy indication. In DCI format 0_1 and 1_1, there is a SCell dormancy indication field which could indicate the dormant or non-dormant state for up to 5 groups of SCells for Case 1 Scell dormancy indication. On the other hand, for Case 2 Scell dormancy indication, a special value of frequency domain resource allocation (FDRA) field indicates that no PDSCH transmission is scheduled and SCell dormancy switching respectively for up to 15 SCells is indicated by reinterpreting some fields in the DCI format 1_1.

When a PDCCH of a scheduling SCell can be configured to schedule a transmission on PCell, it is agreed that the scheduling SCell can be deactivated or dormant too. Therefore, efficient PDCCH design is a critical issue to be considered for DSS enhancement.

Various embodiments herein provide mechanisms to support efficient PDCCH monitoring to schedule a transmission on P(S)Cell considering SCell dormancy switching or SCell (de)activation when cross-carrier scheduling from a SCell to PCell transmission is supported.

When CCS from sSCell to P(S)Cell is configured, a transmission on a primary cell (PCell) or primary secondary cell (PSCell) (also referred to herein as: P(S)Cell) can be scheduled by either the P(S)Cell or a scheduling SCell (sSCell). The sSCell can be deactivated or switched to the dormant BWP, which impacts the PDSCH or PUSCH transmission on P(S)Cell.

### Maximum Number of Monitored PDCCH Candidates and Non-Overlapped CCEs

In some embodiments, the maximum number of monitored PDCCH candidates and non-overlapped CCEs for the PDCCH monitoring on P(S)Cell and the sSCell (to schedule a transmission on P(S)Cell) are controlled by two scaling factors α and β, α≤1, β≤1. For example, α+β=1 or α+β≥1. The PDCCH monitoring on P(S)Cell is considered as α cell. The PDCCH monitoring on sSCell is considered as β cell. The PDCCH monitoring capability for P(S)Cell is split to the two scheduling cells of P(S)Cell and sSCell according to the value pair (α, β).

For example, assuming β=1−α, the maximum number of monitored PDCCH candidates for the PDCCH monitoring on P(S)Cell is └α·min(M_{PDCCH}^{max,slot,μ}^{_{P}}, M_{PDCCH}^{total,slot,μ}^{_{P}})┘ while the corresponding maximum number on sSCell is min(M_{PDCCH}^{max,slot,μ}^{_{P}}, M_{PDCCH}^{total,slot,μ}^{_{P}})−└α·min(M_{PDCCH}^{max,slot,μ}^{_{P}}, M_{PDCCH}^{total,slot,μ}^{_{P}})┘. Further, the corresponding PDCCH PDCCH maximum number on sSCell is further limited by M_{PDCCH}^{max,slot,μ}^{_{S}}. M_{PDCCH}^{max,slot,μ}^{_{P}}is the maximum of monitored PDCCH candidates for P(S)Cell with SCS numerology μ_{P}, M_{PDCCH}^{max,slot,μ}^{_{S}} is the maximum of monitored PDCCH candidates for sSCell with SCS numerology μ_{S}, M_{PDCCH}^{total,slot,μ}^{_{P}} is the maximum of monitored PDCCH candidates for the cells (including P(S)Cell) which have SCS numerology μ_{P} as P(S)Cell.

In the following descriptions, two scaling factors α and β are assumed. As a special case, the solutions are applicable when β can be determined by α, e.g., β=1−α. In such case, the value pair becomes (α, 1−α).

In one embodiment, when a sSCell is configured, a value pair of (α,β) can be predefined or configured by high layer signaling, irrespective of whether the sSCell is activated or not, or irrespective of whether the sSCell is dormant or not. In this scheme, if sSCell is deactivated or dormant, the PDSCH or PUSCH transmission on P(S)Cell can only be scheduled by a PDCCH on P(S)Cell. When sSCell is deactivated or dormant, the UE uses a BWP indicated by the firstActiveDownlinkBWP-Id (as defined in NR) for the sSCell in the determination of the maximum numbers of monitored PDCCH candidates and non-overlapped CCEs for the serving cells. Alternatively, when sSCell is dormant, the UE uses the configured dormant BWP of the sSCell in the determination of the maximum numbers of monitored PDCCH candidates and non-overlapped CCEs for the serving cells. Alternatively, when sSCell is dormant, UE may assume a BWP that is indicated by the firstOutside Active TimeBWP-Id or firstWithinActiveTimeBWP-Id (as defined in NR) for the sSCell.

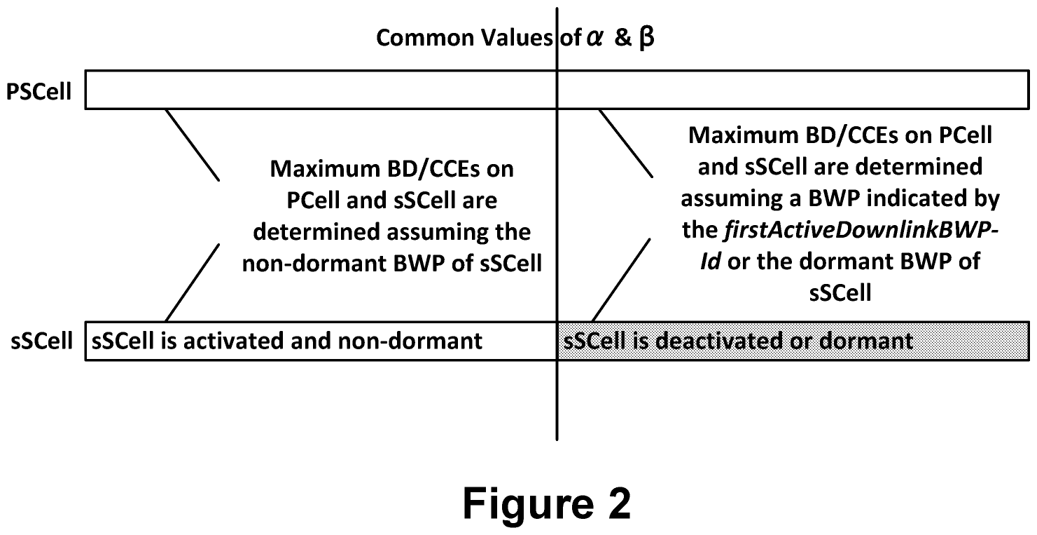

FIG. 2 illustrates an example of applying the same value pair of (α,β) in the determination of maximum numbers of monitored PDCCH candidates and non-overlapped CCEs to a PCell and sSCell, assuming the dormant BWP for the sSCell when the sSCell is switched into the dormant BWP.

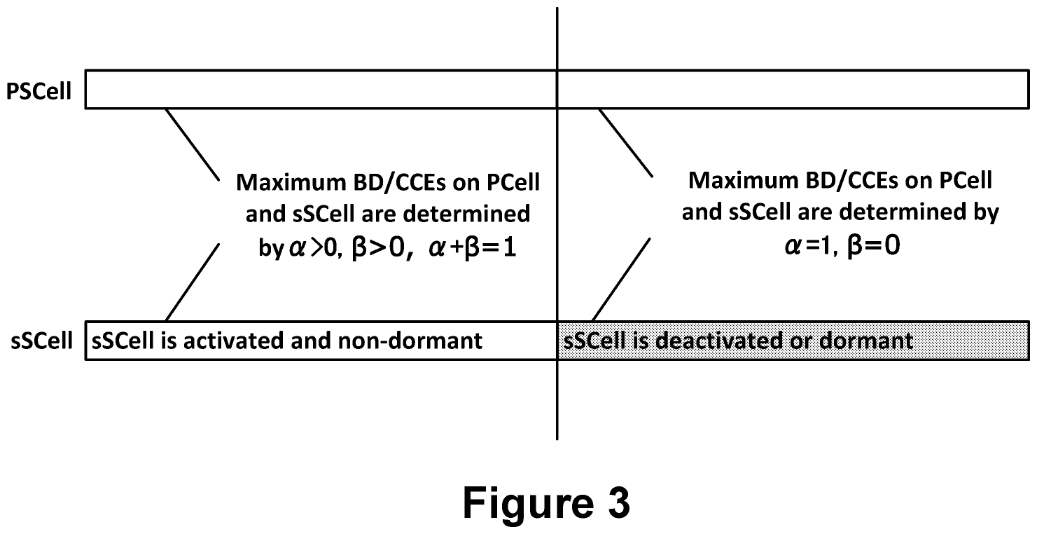

In one embodiment, when a sSCell is configured, the determination of the maximum numbers of monitored PDCCH candidates and non-overlapped CCEs for the serving cells configured to the UE can be dependent on whether the sSCell is activated or not, or whether the sSCell is dormant or not. The different value pairs of (α,β) can be predefined or configured by high layer signaling, for the two cases that sSCell is activated or not activated, or for the two cases that sSCell is dormant or non-dormant. When sSCell is activated or non-dormant, the PDCCH monitoring capability for P(S)Cell is split to the two scheduling cells of P(S)Cell and sSCell. For example, α≤1,0<β≤1, α+β=1 or α+β≥1. When sSCell is deactivated or dormant, the full PDCCH monitoring capability can be applied to P(S)Cell, e.g., α=1,β=0. In other words, CCS from sSCell to P(S)Cell is disabled. FIG. 3 illustrates the change of value pairs of (α,β) when the sSCell become deactivated or switches to dormant BWP. When sSCell is deactivated or dormant, UE only monitors PDCCHs on P(S)Cell and the total numbers of monitored PDCCH candidates and non-overlapped CCEs of P(S)Cell is increased for better gNB scheduling flexibility. When sSCell is deactivated or dormant, the UE may use the configured dormant BWP for the sSCell in the determination of the maximum numbers of monitored PDCCH candidates and non-overlapped CCEs for the serving cells. Alternatively, UE may assume a BWP that is indicated by the firstActiveDownlinkBWP-Id (as defined in NR) for the sSCell. Alternatively, UE may assume a BWP that is indicated by the firstOutsideActiveTimeBWP-Id or firstWithinActiveTimeBWP-Id (as defined in NR) for the sSCell.

In one embodiment, different value pairs of (α,β) can be configured by high layer signaling for the different DL BWPs of P(S)Cell. The configured (α,β) is not changed with the activated BWP of sSCell. Since the interference to/from LTE CRS may be different in the different BWPs of P(S)Cell, therefore, it is beneficial to vary configured (α,β) for the BWPs of P(S)Cell accordingly.

In one embodiment, different value pairs of (α,β) can be configured by high layer signaling for the different DL BWPs of sSCell. The configured (α,β) is not changed with the activated BWP of P(S)Cell. Further, different value pairs of (α,β) can be configured for the BWP indicated by the firstActiveDownlinkBWP-Id (as defined in NR) for the sSCell when sSCell is activated or not activated.

In one embodiment, different value pairs of (α,β) can be configured by high layer signaling for the different combinations of DL BWPs of P(S)Cell and DL BWPs of sSCell. Further, different value pairs of (α,β) can be configured for the BWP indicated by the firstActiveDownlinkBWP-Id (as defined in NR) for the sSCell when sSCell is activated or not activated.

In one option, a common value pair of (α,β) can be configured by high layer signaling for each combination of a DL BWP with SCS up on P(S)Cell and a non-dormant DL BWP with SCS μ_{S} on sSCell, if μ_{P}≤μ_{S}. Otherwise, if μ_{P}>μ_{S}, CSS from sSCell to P(S)Cell is not applicable and the full PDCCH monitoring capability can be applied to P(S)Cell. This can be considered as applying the value pair of (α,β)=(1,0).

In one option, a common value pair of (α,β) can be configured by high layer signaling for each combination of a DL BWP with SCS μ_{P} on P(S)Cell and a non-dormant DL BWP with SCS μ_{S} on sSCell, if μ_{P}≤μ_{S}. The above non-dormant DL BWP on sSCell may not include the default BWP and/or the initial BWP on P(S)Cell. The above non-dormant DL BWP on sSCell may not include the default BWP and/or the initial BWP on sSCell. Otherwise, for other combinations of a DL BWP on P(S)Cell and a DL on sSCell, CSS from sSCell to P(S)Cell is not applicable and the full PDCCH monitoring capability can be applied to P(S)Cell. This can be considered as applying the value pair of (α,β)=(1,0).

In one embodiment, a common value pair of (α,β) can be configured by high layer signaling and applies for each combination of a DL BWP with SCS μ_{P} on P(S)Cell and a non-dormant DL BWP with SCS μ_{S} on sSCell, if μₚ≤μₛ and the DL BWP on the sSCell is activated and non-dormant. Otherwise, if μ_{P}>μ_{S} or the sSCell is deactivated or dormant, CSS from sSCell to P(S)Cell is not applicable and the full PDCCH monitoring capability can be applied to P(S)Cell. This can be considered as applying the value pair of (α,β)=(1,0).

In one embodiment, when a sSCell is configured, the determination of the maximum numbers of monitored PDCCH candidates and non-overlapped CCEs for the serving cells configured to the UE can be dependent on the active search space set group (SSSG) configuration of P(S)Cell. The different value pairs of (α,β) can be predefined or configured by high layer signaling for the different SSSG configurations. For exmaple, the first SSSG configuration may target the PDCCH monitoring on both P(S)Cell and sSCell, hence the value pair of (α,β) may be configured as α≤1,0<β≤1, α+β=1 or α+β≥1. On the other hand, the second SSSG may target the PDCCH monitoring only on P(S)Cell, therefore the value pair of (α,β) may be configured as α=1,β=0, which allows the full PDCCH monitoring capability is applied to P(S)Cell. In this embodiment, the SSSG switching may be dependent on whether sSCell is is activated or not activated, or whether sSCell is dormant or not. Alternatively, SSSG switching may be triggered by existing method defined in NR.

In the above embodiments, when CCS from sSCell to P(S)Cell is configured, for an active DL BWP on P(S)Cell with SCS μ_{P} and an active non-dormant DL BWP on sSCell with SCS μ_{S} and μ_{P}≤μ_{S}s, the configured value pair (α,β) applies to split the PDCCH monitoring capability for P(S)Cell. If the sSCell is deactivated or switched to a dormant BWP, CSS from sSCell to P(S)Cell is not applicable and the full PDCCH monitoring capability can be applied to P(S)Cell, e.g., α=1,β=0. Further, if P(S)Cell and/or sSCell switch to the active DL BWPs that results in larger SCS of P(S)Cell than that of sSCell, CSS from sSCell to P(S)Cell is not applicable and the full PDCCH monitoring capability can be applied to P(S)Cell, e.g., α=1,β=0.

In one embodiment, for CSS from sSCell to P(S)Cell, if value pair (α,β) to split the PDCCH monitoring capability for P(S)Cell is configured by high layer, another indicator is also configured by high layer to configure whether UE needs to monitor a USS set on the P(S)Cell when sSCell is using a non-dormant active DL BWP.
If the indicator indicates ‘no’, when sSCell is using a non-dormant active DL BWP, the UE monitors the USS sets on only sSCell and ignores the configured USS set(s) on P(S)Cell for self-scheduling. Otherwise, when sSCell is deactivated or dormant, the UE can monitor the configured USS set(s) on P(S)Cell for self-scheduling, subjected to the full PDCCH monitoring capability on P(S)Cell.
If the indicator indicates ‘yes’, when sSCell is using a non-dormant active DL BWP, the UE monitors the USS sets on sSCell and the configured USS set(s) on P(S)Cell for self-scheduling subjected to value pair (α,β) to split PDCCH monitoring capability. Otherwise, when sSCell is deactivated or dormant, the UE can monitor the configured USS set(s) on P(S)Cell for self-scheduling, subjected to the full PDCCH monitoring capability on P(S)Cell.

### Timing to Split the Maximum Numbers of Monitored PDCCH Candidates and Non-Overlapped CCEs

When the sSCell is switching between the activation state and deactivation state, or between the dormant BWP and a non-dormant BWP, the determination of the maximum numbers of monitored PDCCH candidates and non-overlapped CCEs for the serving cells of the UE is impacted by the numerologies and/or the value pairs (α,β) before or after the switching. Therefore, it is helpful to define the timeline to do PDCCH monitoring using the old or new numerology and/or the value pair (α,β).

Further, different SSSG configurations can be respectively configured for the case sSCell is activated or deactivated. Consequently, when the sSCell is switching between the activation state and deactivation state, it also triggers SSSG switching accordingly. Similarly, different SSSG configurations can be respectively configured for the case sSCell is dormant or non-dormant. Consequently, when the sSCell is switching between the dormant BWP or a non-dormant BWP, it also triggers SSSG switching accordingly. Therefore, it is helpful to define the timeline to do PDCCH monitoring based on a proper SSSG configuration.

The determination of the maximum numbers of monitored PDCCH candidates and non-overlapped CCEs for the serving cells based on the new numerology of BWP and/or new value pair (α,β), or the new SSSG configuration may be only triggered when sSCell is switched to activation state or switched to non-dormant BWP, or only triggered when sSCell is switched to deactivation state or switched to dormant BWP, or triggered by both directions of switching between the activation state and deactivation state or switching between the dormant BWP and a non-dormant BWP.

In one embodiment, when the sSCell is switching between the activation state and deactivation state, the new numerology of BWP and/or new value pair (α,β), or the new SSSG configuration can be applied starting from timing t. t is in unit of slot or symbol. Assuming a UE receives the PDSCH with a MAC CE for SCell activation or deactivation in slot n, the timing t could be determined by one of the following options:
The slot n+K₁+1 where slot n+k₁ is a slot indicated for PUCCH transmission with HARQ-ACK information for the PDSCH reception. Or,
The slot n+k₁+3 Nₛₗₒₜ^{subframe,μ}+1 where slot n+k₁ is a slot indicated for PUCCH transmission with HARQ-ACK information for the PDSCH reception and Nₛₗₒₜ^{subframe,μ}is a number of slots per subframe for the SCS configuration μ of the PUCCH transmission as defined in TS 38.211. Or,
The slot n+k₁+1+δ where slot n+k₁ is a slot indicated for PUCCH transmission with HARQ-ACK information for the PDSCH reception, δ is an additional slot offset which is predefined or configured by high layer signaling. For sSCell deactivation, δ can range from 0 to 3 Nₛₗₒₜ^{subframe,μ}. For SSSG switching, δ could be the predefined or configured SSSG switching delay of the UE. Or,
The slot n+k₁₊₃ Nₛₗₒₜ^{subframe,μ}+1+δ where slot n+k₁ is a slot indicated for PUCCH transmission with HARQ-ACK information for the PDSCH reception, Nₛₗₒₜ^{subframe,μ} is a number of slots per subframe for the SCS configuration μ of the PUCCH transmission as defined in TS 38.211, and δ is an additional slot offset which is predefined or configured by high layer signaling. For SSSG switching, δ could be the predefined or configured SSSG switching delay of the UE. Or,
For SSSG switching, the slot n+k₁+1+δ+d where slot n+k₁ is a slot indicated for PUCCH transmission with HARQ-ACK information for the PDSCH reception, δ is an additional slot offset which is predefined or configured by high layer signaling, d could be the predefined or configured SSSG switching delay of the UE. Or,
For SSSG switching, the slot n+k₁+3 Nₛₗₒₜ^{subframe,μ}+1+δ+d where slot n+k₁ is a slot indicated for PUCCH transmission with HARQ-ACK information for the PDSCH reception, Nₛₗₒₜ^{subframe,μ} is a number of slots per subframe for the SCS configuration μ of the PUCCH transmission as defined in TS 38.211, and δ is an additional slot offset which is predefined or configured by high layer signaling, d could be the predefined or configured SSSG switching delay of the UE. Or,
The time when sSCell activation or sSCell deactivation is completed. That is, the timing t is no later than the minimum requirement defined in TS 38.133 and no earlier than slot n+k. Or, The slot

$$n + 1 + \frac{{T}_{H A R Q} + {T}_{activation\_time} + {T}_{CSI\_Reporting}}{NR slot length of PUCCH}$$

where T_{HARQ}, T_{activation_time} and T_{CSI_Reporting} are delay values as defined in TS 38.133. The slot

$$n + \frac{{T}_{H A R Q} + {T}_{activation\_time} + {T}_{CSI\_Reporting}}{NR slot length of PUCCH}$$

is the time when the sSCell is activated.

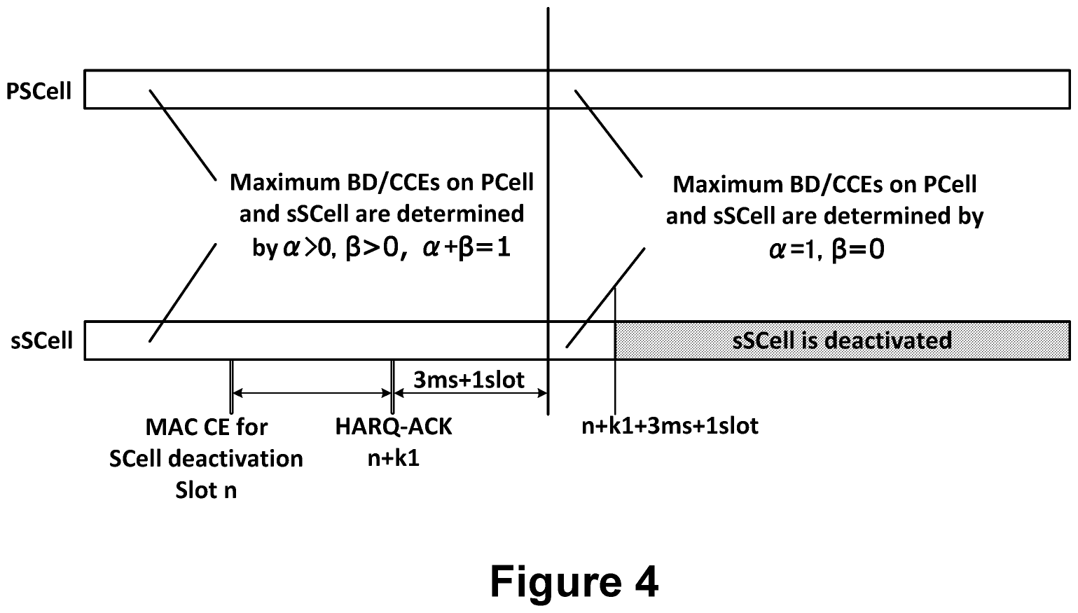

FIG. 4 illustrates an example of the timeline to change the determination of maximum numbers of monitored PDCCH candidates and non-overlapped CCEs (BD/CCE) when sSCell is deactivated. It is assumed that the UE can use a different split of maximum BD/CCEs for PCell from slot n+k₁+1+δ, δ<3 Nₛₗₒₜ^{subframe,μ}, though the sSCell may be deactived at slot n+k₁+3 Nₛₗₒₜ^{subframe,μ}.

In another embodiment, when the sSCell is switching between the dormant BWP and a non-dormant BWP, the new numerology of BWP and/or new value pair (α,β), or the new SSSG configuration can be applied starting from timing t. t is in unit of slot or symbol.

In one option, assuming a UE receives a DCI triggering SCell dormancy switching in slot n, the timing t could be determined by one of the following options:
The slot indicated by the slot offset value of the time domain resource assignment field in the DCI format. The slot is slot

$$⌊ n \cdot \frac{{2}^{{μ}_{P D S C H}}}{{2}^{{μ}_{P D C C H}}} ⌋ + {K}_{0}$$

or slot

$$⌊ n \cdot \frac{{2}^{{μ}_{P U S C H}}}{{2}^{{μ}_{P D C C H}}} ⌋ + {K}_{2} ,$$

where K₀, K₀, μ_{PDSCH}, μ_{PUSCH} and μ_{PDCCH} are as defined in TS 38.214. Or,
The slot n+k₁+1 where slot n+k₁ is a slot indicated for PUCCH transmission with HARQ-ACK information for the PDSCH reception that is scheduled by the DCI triggering SCell dormancy switching. Or,
The slot n+1+δ where δ is an offset which is predefined or configured by high layer signaling for the processing time. δ could be determined by the switching delay between a dormant BWP and a non-dormant BWP as defined in TS 38.133. For SSSG switching, δ could be the predefined or configured SSSG switching delay of the UE. Alternatively, for SSSG switching, δ=max(d₁, d₂), where d₁ is the switching delay between a dormant BWP and a non-dormant BWP d₂ of the UE, d₂ is the SSSG switching delay of the UE. Or,
The slot n+1+max(k₁, δ) where k₁ is the delay to PUCCH transmission with HARQ-ACK information for the PDSCH reception that is scheduled by the DCI triggering SCell dormancy switching, δ is an offset which is predefined or configured by high layer signaling for the processing time. δ could be determined by the switching delay between a dormant BWP and a non-dormant BWP. For SSSG switching, δ could be the predefined or configured SSSG switching delay of the UE. Alternatively, for SSSG switching, δ=max(d₁, d₂), where d₁ is the switching delay between a dormant BWP and a non-dormant BWP d₂ of the UE, d₂ is the SSSG switching delay of the UE. Or,
The slot n+k₁+1+δ where slot n+k₁ is a slot indicated for PUCCH transmission with HARQ-ACK information for the PDSCH reception, δ could be determined by the switching delay between a dormant BWP and a non-dormant BWP. For SSSG switching, δ could be the predefined or configured SSSG switching delay of the UE. Alternatively, for SSSG switching, δ=max(d₁, d₂), where d₁ is the switching delay between a dormant BWP and a non-dormant BWP d₂ of the UE, d₂ is the SSSG switching delay of the UE. Or,
For SSSG switching, the slot n+1+δ+d where δ is an additional slot offset which is predefined or configured by high layer signaling, d could be the predefined or configured SSSG switching delay of the UE. Or,
For SSSG switching, the slot n+k₁+1+δ+d where slot n+k₁ is a slot indicated for PUCCH transmission with HARQ-ACK information for the PDSCH reception, δ is an additional slot offset which is predefined or configured by high layer signaling, d could be the predefined or configured SSSG switching delay of the UE.

If SCell dormancy switching is triggered by DCI format 1_1 without scheduled PDSCH, the PDSCH-to-HARQ_feedback timing indicator field in the DCI can still indicate a value k₁, which can be used in determination of timing t. If SCell dormancy switching is triggered by DCI format 1_1 without scheduled PDSCH or DCI format 0_1, the value k₁ which is used in determination of timing t can be predefined or configured by high layer signaling.

If SCell dormancy switching is triggered by DCI format 1_1 without scheduled PDSCH, the TDRA field in the DCI can still indicate a value K₀, which can be used in determination of timing t. If SCell dormancy switching is triggered by DCI format 1_1 without scheduled PDSCH or DCI format 0_1, the value K₀ which is used in determination of timing t can be predefined or configured by high layer signaling.

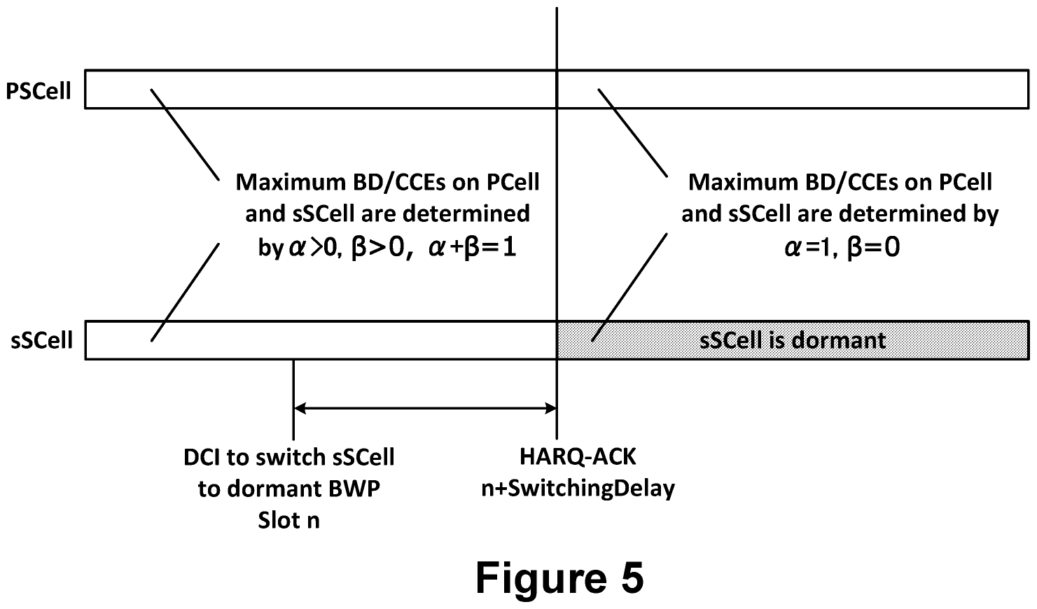

FIG. 5 illustrates an example of the timeline to change the determination of maximum numbers of monitored PDCCH candidates and non-overlapped CCEs (BD/CCE) when sSCell switches to the dormant BWP. It is assumed that the UE can use a different split of maximum BD/CCEs for PCell after dormancy switching.

In another option, if the dormant BWP is the default BWP of the sSCell, a UE may switch to the default BWP, e.g. the dormant BWP due to a BWP inactivity timer expiration if the UE is provided by bwp-InactivityTimer a timer value for the sSCell. Assuming BWP inactivity timer expires in subframe n, the timing t could be determined by one of the following options:
The subframe n+δ where δ is an offset which is predefined or configured by high layer signaling for the processing time. δ could be determined by the switching delay between a dormant BWP and a non-dormant BWP. For SSSG switching, δ could be the predefined or configured SSSG switching delay of the UE. Alternatively, for SSSG switching, δ=max(d₁, d₂), where d₁ is the switching delay between a dormant BWP and a non-dormant BWP d₂ of the UE, d₂ is the SSSG switching delay of the UE. Or,
For SSSG switching, the subframe n+δ+d where δ is an additional offset which is predefined or configured by high layer signaling, d could be the predefined or configured SSSG switching delay of the UE.

Based on the above embodiments to define timing t, a common option may be applied to both cases that sSCell is switched from activation state to deactivation state or from deactivation state to activation state, or both cases that sSCell is switched from dormant BWP to non-dormant BWP or from non-dormant BWP to dormant BWP.

Alternatively, based on the above embodiments to define timing t, different options may be respectively applied to the two cases that sSCell is switched from activation state to deactivation state or from deactivation state to activation state, or the two cases that sSCell is switched from dormant BWP to non-dormant BWP or from non-dormant BWP to dormant BWP.

### PDCCH Monitoring Capability to Support the Scheduling of PCell Transmission by a PDCCH on SCell for NR Operations

In NR, all transmissions of a first cell are scheduled by PDCCHs in a single cell which is the first cell itself in self-scheduling or is a second cell in cross-carrier scheduling. For cross-carrier scheduling with different numerology, the limitation on the numbers of monitored PDCCH candidates and non-overlapped CCEs is derived by the numerology of the scheduling cell. There are two PDCCH monitoring budgets. For a DL BWP with SCS configuration μ for a UE per time unit for operation with a single serving cell, the maximum numbers of monitored PDCCH candidates and non-overlapped CCEs are respectively denoted as M_{PDCCH}^{max,slot,μ} and C_{PDCCH}^{max,slot,μ}. The above time unit could be a slot or a span of PDCCH monitoring occasions. Additionally, for carrier aggregation, the maximum numbers of monitored PDCCH candidates and non-overlapped CCEs for the serving cells with the sane SCS configuration μ are denoted as M_{PDCCH}^{total,slot,μ} and C_{PDCCH}^{total,slot,μ} respectively.

In some embodiments, if a UE is configured with N_{cells}^{DL,μ} downlink cells with DL BWPs having SCS configuration μ where Σ_{μ=0}^{N}^{_{μ}}N_{cells}^{DL,μ}≤N_{cells}^{cap}, the UE is not required to monitor, on the active DL BWP of the scheduling cell, more than M_{PDCCH}^{total,slot,μ}=M_{PDCCH}^{max,slot,μ} PDCCH candidates or more than C_{PDCCH}^{total,slot,μ}=C_{PDCCH}^{max,slot,μ} non-overlapped CCEs per time unit for each scheduled cell. N_{cells}^{cap} is a number of cells determined by UE capability.

If a UE is configured with N_{cells}^{DL,μ} downlink cells with DL BWPs having SCS configuration μ, where Σ_{μ=0}^{N}^{_{μ}}N_{cells}^{DLμ}<N_{cells}^{cap}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,slot,μ}=└N_{cells}^{cap}·M_{PDCCH}^{max,slot,μ}·N_{cells}^{DL,μ}/Σⱼ₌₀^{N}^{_{μ}}N_{cells}^{DL,j}┘ PDCCH candidates or more than C_{PDCCH}^{total,slot,μ}=└N_{cells}^{cap}·C_{PDCCH}^{max,slot,μ}·N_{cells}^{DL,μ}/Σ_{jp32 0}^{N}^{_{μ}}N_{cells}^{DL,j}┘ non-overlapped CCEs per time unit on the active DL BWP(s) of scheduling cell(s) from the N_{cells}^{DL,μ} downlink cells.

For each scheduled cell, the UE is not required to monitor on the active DL BWP with SCS configuration μ of the scheduling cell more than min(M_{PDCCH}^{max,slot,μ}, M_{PDCCH}^{total,slot,μ}) PDCCH candidates or more than min(C_{PDCCH}^{max,slot,μ}, C_{PDCCH}^{total, slot,μ}) non-overlapped CCEs per time unit.

DSS was considered since NR Rel-15. For example, a CRS pattern can be configured for NR UE, so that the PDSCH transmission of a NR carrier could be rate matched around the REs potentially used by LTE CRS, which mitigates the impact to LTE channel estimation for better LTE DL performance. For example, NR transmission should be avoided on the resource used by

LTE PDCCH. The consideration of LTE CRS/PDCCH causes limitation on the NR PDCCH transmissions. Therefore, it was proposed to support that a PDCCH of SCell could schedule PDSCH and/or PUSCH transmissions of PCell, and a PDCCH could schedule PDSCH transmission on two cells. Therefore, efficient PDCCH design is a critical issue to be considered for DSS enhancement.

Various embodiments herein provide mechanisms for handling PDCCH monitoring capability to support the scheduling of PCell transmission by a PDCCH on SCell for NR operations.

If a transmission on PCell could be scheduled by a scheduling SCell (sSCell), it is expected that a UE needs to detect a PDCCH on PCell and a PDCCH on the sSCell that schedules a transmission on PCell. The common search space (CSS) sets may still be configured on PCell, while the UE specific search space set (USS) sets can be configured on the sSCell. Alternatively, the USS sets can be configured on both PCell and the sSCell. The USS sets can be configured in same slot or symbols on PCell and sSCell, or only configured in different slots or symbols on PCell and sSCell. The PDCCH overbooking operation may only apply to USS sets on PCell.

In the PDCCH monitoring for PCell, the maximum numbers of monitored PDCCH candidates and non-overlapped CCEs are separately determined for the PDCCH monitoring on PCell and the PDCCH monitoring on sSCell that that schedules a transmission on PCell. The PCell may have same or different numerology from sSCell. Denote the SCS configuration of PCell as μₚ, the SCS configuration of sSCell as μₛ. The time unit of a serving cell is defined as a slot or a span on the serving cell.

The PDCCH monitoring for PCell can be determined based on a fractional number p of a cell with numerology μₚ and a fractional number s of a cell with numerology μₛ, p≤1,s≤1. In one example, p+s=1, so PDCCH monitoring for PCell is still considered as for one virtual cell. In another example, p+s>1, so PDCCH monitoring budget for PCell is increased to allow more flexible PDCCH transmission for PCell. The value p and s can be predefined or configured by high layer signaling.

In one embodiment, the maximum numbers of monitored PDCCH candidates and non-overlapped CCEs for the PDCCH monitoring on sSCell that schedules a transmission on PCell are determined by numerology μₛ of sSCell. It assumes that, N_{cells}^{DL,μ}^{ₚ}=P+p cells with same numerology μₚ as PCell and N_{cells}^{DL,μ}=S+s cells with same numerology μₛ as sSCell. The active DL BWP of P SCells use same numerology μₚ. The active DL BWP of S SCells use same numerology μₛ.

For the PDCCH monitoring on PCell, the maximum numbers of monitored PDCCH candidates and non-overlapped CCEs can be determined by p·M_{PDCCH}^{max,slot,μ}^{ₚ} and p·C_{PDCCH}^{max,slot,μ}^{ₚ} per time unit of PCell respectively. Further, M_{PDCCH}^{total,slot,μ}^{ₚ} and C_{PDCCH}^{total,slot,μ}^{ₚ} per time unit of PCell can be determined assuming N_{cells}^{DL,μ}^{ₚ}=P+p cells with same numerology μₚ as PCell. For example,
If Σ_{μ×0}^{N}^{_{μ}}N_{cells}^{DL,μ}≤N_{cells}^{cap}, the UE is not required to monitor per time unit of PCell, on the active DL BWP of the PCell, more than M_{PDCCH}^{total,slot,μ}^{ₚ}=p·M_{PDCCH}^{max,slot,μ}^{ₚ} PDCCH candidates or more than C_{PDCCH}^{total,slot,μ}^{ₚ}=p·C_{PDCCH}^{max,slot,μ}^{ₚ} non-overlapped CCEs.
If Σ_{μ=0}^{N}^{_{μ}}N_{cells}^{DL,μ}>N_{cells}^{cap}, the UE is not required to monitor per time unit of PCell, on the active DL BWP(s) of PCell, more than M_{PDCCH}^{total,slot,μ}^{ₚ}└p·N_{cells}^{cap}·M_{PDCCH}^{max,slot,μ}^{ₚ}·N_{cells}^{DL,μ}^{ₚ}/Σⱼ₌₀^{N}^{_{μ}}N_{cells}^{DL,j}┘ PDCCH candidates or more than C_{PDCCH}^{total,slot,μ}^{ₚ}=└p·N_{cells}^{cap}·C_{PDCCH}^{max,slot,μ}^{ₚ}·N_{cells}^{DL,μ}^{ₚ}/Σⱼ₌₀^{N}^{_{μ}}N_{cells}^{DL,j}┘ non-overlapped CCEs.

Therefore, for the PDCCH monitoring on PCell, the UE is not required to monitor per time unit of PCell, on the active DL BWP of the PCell, more than min(p·M_{PDCCH}^{max,slot,μ}^{ₚ},M_{PDCCH}^{total,slot,μis p}) PDCCH candidates or more than min(p·C_{PDCCH}^{max,slot,μ}^{ₚ}C_{PDCCH}^{total,slot,μ}^{ₚ}) non-overlapped CCEs.

For the PDCCH monitoring that are configured on sSCell and schedules a transmission on PCell, a pair of maximum numbers of monitored PDCCH candidates and non-overlapped CCEs can be determined as by s·M_{PDCCH}^{max,slot,μ}^{ₛ} and s·C_{PDCCH}^{max,slot,μ}^{ₛ} per time unit of sSCell respectively. Further, M_{PDCCH}^{total,slot,μ}^{ₛ} and C_{PDCCH}^{total,slot,μ}^{ₛ} per time unit of sSCell can be determined assuming N_{cells}^{DL,μ}^{ₛ}=S+s cells with same numerology μₛ as sSCell. For example,
If Σ_{μ=0}^{N}^{_{μ}}N_{cells}^{DL,μ}≤N_{cells}^{cap}, the UE is not required to monitor per time unit on sSCell, on the active DL BWP(s) of sSCell, more than M_{PDCCH}^{total,slot,μ}^{ₛ}=s·M_{PDCCH}^{max,slot,μ}^{ₛ} PDCCH candidates or more than C_{PDCCH}^{total,slot,μ}^{ₛ}=s·C_{PDCCH}^{max,slot,μ}^{ₛ} non-overlapped CCEs.
If Σ_{μ=0}^{N}^{ᵤ}N_{cells}^{DL,μ>N}_{cells}^{cap}, the UE is not required to monitor per time unit of sSCell, on the active DL BWP(s) of sSCell, more than M_{PDCCH}^{total,slot,μ}^{ₛ}=└s·N_{cells}^{cap}·M_{PDCCH}^{max,slot,μ}^{ₛ}19 N_{cells}^{DL,μ}^{ₛ}/Σⱼ₌₀^{N}^{_{μ}}N_{cells}^{DL,j}┘ PDCCH candidates or more than C_{PDCCH}^{total,slot,μ}^{ₛ}=└s·N_{cells}^{cap}·C_{PDCCH}^{max,slot,μ}^{ₛ}·N_{cells}^{DL,μ}^{ₛ}/Σⱼ₌₀^{N}^{_{μ}}N_{cells}^{DL,j}┘ non-overlapped CCEs.

Therefore, for the PDCCH monitoring that are configured on sSCell and schedules a transmission on PCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs.

In one embodiment, the PCell is considered as p+s cell with SCS configuration μₚ, so that the total numbers of monitored PDCCH candidates and non-overlapped CCEs on PCell and sSCell do not exceed the corresponding maximum numbers of p+s cell with SCS configuration μₚ. It assumes that, N_{cells}^{DL,μ}^{ₚ}=P+p cells with same numerology μₚ as PCell and N_{cells}^{DL,μ}^{ₛ}=S+s cells with same numerology μₛ as sSCell. The active DL BWP of P SCells use same numerology μₚ. The active DL BWP of S SCells use same numerology μₛ.

For the PDCCH monitoring on PCell, the maximum numbers of monitored PDCCH candidates and non-overlapped CCEs can be determined by p·M_{PDCCH}^{max,slot,μ}^{ₚ} and p·C_{PDCCH}^{max,slot,μis p} per time unit of PCell respectively. Further, M_{PDCCH}^{total,slot,μ}^{ₚ} and C_{PDCCH}^{total,slot,μ}^{ₚ} per time unit of PCell can be determined assuming N_{cells}^{DL,μ}^{ₚ}=P+p cells with same numerology μₚ as PCell. For example,
If Σ_{μ=0}^{N}^{_{μ}}N_{cells}^{DL,μ≤N}_{cells}^{cap}, the UE is not required to monitor per time unit of PCell, on the active DL BWP of the PCell, more than M_{PDCCH}^{total,slot,μ}^{ₚ}=p·M_{PDCCH}^{max,slot,μ}^{ₚ} PDCCH candidates or more than C_{PDCCH}^{total,slot,μ}^{ₚ}=p·C_{PDCCH}^{max,slot,μ}^{ₚ} non-overlapped CCEs.
If Σ_{μ=0}^{N}^{_{μ}}N_{cells}^{DL,μ}>N_{cells}^{cap}, the UE is not required to monitor per time unit of PCell, on the active DL BWP(s) of PCell, more than M_{PDCCH}^{total,slot,μ}^{ₚ}=└N_{cells}^{cap}·M_{PDCCH}^{max,slot,μ}^{ₚ}·N_{cells}^{DL,μ}^{ₚ}/Σⱼ₌₀^{N}^{_{μ}}N_{cells}^{DL,j}┘ PDCCH candidates or more than C_{PDCCH}^{total,slot,μ}^{ₚ}=└N_{cells}^{cap}·C_{PDCCH}^{max,slot,μ}^{ₚ}·N_{cells}^{DL,μ}^{ₚ}/Σⱼ₌₀^{N}^{_{μ}}N_{cells}^{DL,j}┘ non-overlapped CCEs. Alternatively, M_{PDCCH}^{total,slot,μ}^{ₚ}=└p·N_{cells}^{cap·M}_{PDCCH}^{max,slot,μ}^{ₚ}·N_{cells}^{DL,μ}^{ₚ}/Σⱼ₌₀^{N}^{_{μ}}N_{cells}^{DL,j}┘, C_{PDCCH}^{total,slot,μ}^{ₚ}=└p·N_{cells}^{cap}·C_{PDCCH}^{max,slot,μ}^{_{p·N}}_{cells}^{DL,μ}^{ₚ}/Σⱼ₌₀^{N}^{_{μ}}N_{cells}^{DL,j┘.}

Therefore, for the PDCCH monitoring on PCell, the UE is not required to monitor per time unit of PCell, on the active DL BWP of the PCell, more than min(p·M_{PDCCH}^{max,slot,μ}^{ₚ},M_{PDCCH}^{total,slot,μ}^{ₚ} PDCCH candidates or more than min(p·C_{PDCCH}^{max,slot,μ}^{ₚ},C_{PDCCH}^{total,slot,μ}^{ₚ}) non-overlapped CCEs.

For the PDCCH monitoring that are configured on sSCell and schedules a transmission on PCell, a pair of maximum numbers of monitored PDCCH candidates and non-overlapped CCEs can be determined as by s·M_{PDCCH}^{max,slot,μ}^{ₛ} and s·C_{PDCCH}^{max,slot,μ}^{ₛ} per time unit of sSCell respectively. Further, M_{PDCCH}^{total,slot,μ}^{ₛ} and C_{PDCCH}^{total,slot,μ}^{ₛ} per time unit on sSCell can be determined assuming N_{cells}^{DL,μ}^{ₛ}=S+s cells with same numerology μₛ as sSCell. For example,
If Σ_{μ=0}^{N}^{_{μ}}N_{cells}^{DL,μ}≤N_{cells}^{cap}, the UE is not required to monitor per time unit on sSCell, on the active DL BWP of the sSCell, more than M_{PDCCH}^{total,slot,μ}^{ₛ}=s·M_{PDCCH}^{max,slot,μ}^{ₛ} PDCCH candidates or more than C_{PDCCH}^{total,slot,μ}^{ₛ}=s·C_{PDCCH}^{total,slot,μ}^{ₛ} non-overlapped CCEs.
If Σ_{μ=0}^{N}^{_{μ}}N_{cells}^{DL,μ}>N_{cells}^{cap},the UE is not required to monitor per time unit of sSCell, on the active DL BWP(s) of sSCell, more than total.slot.us M_{PDCCH}^{total,slot,μ}^{ₛ}=└N_{cells}^{cap}·M_{PDCCH}^{max,slot,μ}^{ₛ}·N_{cells}^{DL,μ}^{ₛ}/Σⱼ₌₀^{N}^{_{μ}}N_{cells}^{DL,j}┘ PDCCH candidates or more than C_{PDCCH}^{total,slot,μ}^{ₛ}=└N_{cells}^{cap}·C_{PDCCH}^{max,slot,μ}^{ₛ}·N_{cells}^{DL,μ}^{ₛ}/Σⱼ₌₀^{N}^{_{μ}}N_{cells}^{DL,j}┘ non-overlapped CCEs. Alternatively, M_{PDCCH}^{total,slot.μ}^{ₛ}=┘s·N_{cells}^{cap}·M_{PDCCH}^{max,slot,μ}^{ₛ}·N_{cells}^{DL,μ}^{ₛ}/Σⱼ₌₀^{N}^{_{μ}}N_{cells}^{DL,j}┘, C_{PDCCH}^{total,slot,μ}ᵢₛ=└s·N_{cells}^{cap}·C_{PDCCH}^{max,slot,μ}^{ₛ}·N_{cells}^{DL,μ}^{ₛ}/Σⱼ₌₀^{N}^{_{μ}}N_{cells}^{DL,j}540 .

Therefore, for the PDCCH monitoring that are configured on sSCell and schedules a transmission on PCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs. Further, another pair of maximum numbers of monitored PDCCH candidates and non-overlapped CCEs can be determined as s·M_{PDCCH}^{max,slot,μ}^{ₚ} and s·C_{PDCCH}^{max,slot,μ}^{ₚ} respectively. The UE is not required to monitor per time unit of PCell, on the active DL BWP of the sSCell, more than s·. M_{PDCCH}^{max,slot,μ}^{ₚ} PDCCH candidates or more than s·C_{PDCCH}^{max,slot,μ}^{ₚ} non-overlapped CCEs.

Alternatively, for the PDCCH monitoring that are configured on sSCell and schedules a transmission on PCell, the UE is not required to monitor per time unit of the sSCell, on the active DL BWP of the sSCell, more than min(M_{PDCCH}^{max,slot,μ}^{ₛ}, M_{PDCCH}^{total,slot,μ}^{ₛ} PDCCH candidates or more than min(C_{PDCCH}^{max,slot,μ}^{ₛ}, C_{PDCCH}^{total,slot,μ}^{ₛ}) non-overlapped CCEs. Further, another pair of maximum numbers of monitored PDCCH candidates and non-overlapped CCEs can be determined as s·M_{PDCCH}^{max,slot,μ}^{ₚ}and s·C_{PDCCH}^{max,slot,μ}^{ₚ} respectively. The UE is not required to monitor per time unit of PCell, on the active DL BWP of the sSCell, more than s·M_{PDCCH}^{max,slot,μ}^{ₚ} PDCCH candidates or more than s·C_{PDCCH}^{max,slot,μ}^{ₚ} non-overlapped CCEs.

Further, for the PDCCH monitoring that are configured on sSCell and schedules a transmission on PCell, M_{PDCCH}^{total,slot,μ}^{ₚ}, and C_{PDCCH,s}^{total,slot,μ}^{ₚ} per time unit of PCell can be determined

DL.up=P+p cells with same numerology up as PCell and NouPs=S+s cells with assuming N_{cells}^{DL,μ}^{ₚ}=P=p cells with same numerology μₚ as PCell and N_{cells}^{DL,μ}^{ₛ}=S+s cells with same numerology μₛ as sSCell. For example,
If Σ_{μ=0}^{N}^{_{μ}}N_{cells}^{DL,μ≤N}_{cells}^{cap}, the UE is not required to monitor per time unit of PCell, on the active DL BWP of the sSCell, more than M_{PDCCH,s}^{total,slotμ}^{ₚ}=M_{PDCCH}^{max,slot,μ}^{ₚ} PDCCH candidates or more than C_{PDCCH,s}^{total,slot,μ}^{ₚ}=s·C_{PDCCH}^{max,slot,μ}^{ₚ} non-overlapped CCEs.
If Σ_{μ=0}^{N}^{_{μ}}N_{cells}^{DL,μ>N}_{cells}^{cap}, the UE is not required to monitor per time unit of PCell, on the active DL BWP(s) of sSCell, more than M_{PDCCH,s}^{total,slot,μ}^{ₚ}=└N_{cells}^{cap}·M_{PDCCH}^{max,slot,μ}^{ₚ}·N_{cells}^{DL,μ}^{ₚ}/Σⱼ₌₀^{N}^{_{μ}}N_{cells}^{DL,j}┘ PDCCH candidates or more than C_{PDCCH,s}^{total,slot,μ}^{ₚ}=└N_{cells}^{cap}·C_{PDCCH}^{max,slot,μ}^{ₚ}·N_{cells}^{DL,μ}^{ₚ}/Σⱼ₌₀^{N}^{_{μ}}N_{cells}^{DL,j}┘ non-overlapped CCEs. Alternatively, M_{PDCCH,s}^{total,slot,μ}^{ₚ}=└s·N_{cells}^{cap}·M_{PDCCH}^{max,slot,μ}^{ₚ}·N_{cells}^{DL,μ}^{ₚ}/Σⱼ₌₀^{N}^{_{μ}}N_{cells}^{DL,j}┘, C_{PDCCH,s}^{total,slot,μ}^{ₚ}=└s·N_{cells}^{cap}·C_{PDCCH}^{max,slot,μ}^{ₚ}·N_{cells}^{DL,μ}^{ₚ}/Σⱼ₌₀^{N}^{_{μ}}N_{cells}^{DL,j}┘.

Therefore, for the PDCCH monitoring that are configured on sSCell and schedules a transmission on PCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs. Further, the UE is not required to monitor per time unit of PCell, on the active DL BWP of the sSCell, more than min(s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ}, C_{PDCCH,s}^{max,slot,μ}^{ₚ}) non-overlapped CCEs.

Alternatively, for the PDCCH monitoring that are configured on sSCell and schedules a transmission on PCell, the UE is not required to monitor per time unit of the sSCell, on the active DL BWP of the sSCell, more than min(M_{PDCCH}^{max,slot,μ}^{_{s,M}}_{PDCCH}^{total,slot,μ}^{ₛ}) PDCCH candidates or more than min(C_{PDCCH}^{max,slot,μ}^{ₛ},C_{PDCCH}^{total,slot,μ}^{ₛ}) non-overlapped CCEs. Further, the UE is not required to monitor per time unit of PCell, on the active DL BWP of the sSCell, more than min(s·M_{PDCCH}^{max,slot,μ}^{ₚ},M_{PDCCH}^{total,slot,μ}^{ₚ}) PDCCH candidates or more than min(s·C_{PDCCH}^{max,slot,μ}^{ₚ},C_{PDCCH}^{total,slot,μ}^{ₚ}) non-overlapped CCEs.

In another embodiment, the PCell is considered as p+s cell with SCS configuration μₚ, the total numbers of monitored PDCCH candidates and non-overlapped CCEs on PCell and sSCell do not exceed the corresponding maximum numbers of p+s cell with SCS configuration μₚ. It assumes that, N_{cells}^{DL,μ}^{ₚ}=P+p+s cells with same numerology up as PCell and N_{cells}^{DL,μ}^{ₛ}=S cells with same numerology μₛ as sSCell. The active DL BWP of P SCells use same numerology μₚ. The active DL BWP of S SCells use same numerology μₛ.

For the PDCCH monitoring on PCell, the maximum numbers of monitored PDCCH candidates and non-overlapped CCEs can be determined by p·M_{PDCCH}^{max,slot,μ}^{ₚ} and p·C_{PDCCH}^{max,slot,μ}^{ₚ} per time unit of PCell respectively. Further, M_{PDCCH}^{total,slot,μ}^{ₚ} and C_{PDCCH}^{total,slot,μ}^{ₚ} per time unit of PCell can be determined assuming N_{cells}^{DL,μ}^{ₚ}=P+p+s cells with same numerology μₚ as PCell and N_{cells}^{DL,μ}^{ₛ}=S cells with same numerology μₛ as sSCell. For example,
If Σ_{μ=0}^{N}^{_{μ}}N_{cells}^{DL,μ}≤N_{cells}^{cap}, the UE is not required to monitor per time unit of PCell, on the active DL BWP of the PCell, more than M_{PDCCH}^{total,slot,μ}^{ₚ}=p·M_{PDCCH}^{max,slot,μ}^{ₚ} PDCCH candidates or more than C_{PDCCH}^{total,slot,μ}^{ₚ}=p·C_{PDCCH}^{max,slot,μ}^{ₚ} non-overlapped CCEs.
If Σ_{μ=0}^{N}^{_{μ}}N_{cells}^{DL,μ>N}_{cells}^{cap}, the UE is not required to monitor per time unit of PCell, on the active DL BWP(s) of PCell, more than M_{PDCCH}^{total,slot,μ}^{ₚ}=└p·N_{cells}^{cap}·M_{PDCCH}^{max,slot,μ}^{ₚ}·N_{cells}^{DL,μ}^{ₚ}/Σⱼ₌₀^{N}^{_{μ}}N_{cells}^{DL,j}┘ PDCCH candidates or more than C_{PDCCH}^{total,slot,μ}^{ₚ}=p·N_{cells}^{cap}·C_{PDCCH}^{max,slot,ρ}^{ₚ}·N_{cells}^{DL,μ}^{ₚ}/Σⱼ₌₀^{N}^{_{μ}}N_{cells}^{DL,j}┘ non-overlapped CCEs.

Therefore, for the PDCCH monitoring on PCell, the UE is not required to monitor per time unit of PCell, on the active DL BWP of the PCell, more than min(p·M_{PDCCH}^{max,slot,μ}^{ₚ}, M_{PDCCH}^{total,slot,μ}^{ₚ}) PDCCH candidates or more than min(p·C_{PDCCH}^{max,slot,μ}^{ₚ}, C_{PDCCH}^{total,slot,μ}^{ₚ}) non-overlapped CCEs.

For the PDCCH monitoring that are configured on sSCell and schedules a transmission on PCell, another pair of maximum numbers of monitored PDCCH candidates and non-overlapped CCEs can be determined as s·M_{PDCCH}^{max,slot,μ}^{ₚ} and s·C_{PDCCH}^{max,slot,μ}^{ₚ} per time unit of PCell respectively. Further, M_{PDCCH,s}^{total,slot,μ}^{ₚ} and C_{PDCCH,s}^{total,slot,μ}^{ₚ} per time unit of PCell can be determined assuming N_{cells}^{DL,μ}^{ₚ}=P+p+s cells with same numerology μₚ as PCell and N_{cells}^{DL,μ}^{ₛ}=S cells with same numerology μₛ as sSCell. For example,
If Σ_{μ=0}^{N}^{_{μ}}N_{cells}^{DL,μ≤N}_{cells}^{cap}, the UE is not required to monitor per time unit of PCell, on the active DL BWP of the sSCell, more than M_{PDCCH}^{total,slot,μ}^{ₚ}=s·M_{PDCCH}^{max,slot,μ}^{ₚ} PDCCH candidates or more than C_{PDCCH}^{total,slot,μ}^{ₚ}=s·C_{PDCCH}^{max,slot,μ}^{ₚ} non-overlapped CCEs.
If Σ_{μ=0}^{N}^{_{μ}}N_{cells}^{DL,μ>N}_{cells}^{cap}, the UE is not required to monitor per time unit of PCell, on the active DL BWP(s) of sSCell, more than M_{PDCCH,s}^{total,slot,μ}^{ₚ}=└s·N_{cells}^{cap}·M_{PDCCH}^{max,slot,μ}^{ₚ}·N_{cells}^{DL,μ}^{ₚ}/Σⱼ₌₀^{N}^{_{μ}}N_{cells}^{DL,j}┘ PDCCH candidates or more than C_{PDCCH}^{total,slot,μ}^{ₚ}=└s·N_{cells}^{cap}·C_{PDCCH}^{max,slot,μ}^{ₚ}·N_{cells}^{DL,μ}^{ₚ}/Σⱼ₌₀^{N}^{_{μ}}N_{cells}^{DL,j}┘ non-overlapped CCEs.

Therefore, for the PDCCH monitoring that are configured on sSCell and schedules a transmission on PCell, the UE is not required to monitor per time unit of the sSCell, on the active DL BWP of the sSCell, more than s·M_{PDCCH}^{max,slot,μ}^{ₛ} PDCCH candidates or more than s·C_{PDCCH}^{max,slot,μ}^{ₛ} non-overlapped CCEs. Further, the UE is not required to monitor per time unit of PCell, on the active DL BWP of the sSCell, more than min(s·M_{PDCCH}^{max,slot,μ}^{ₚ},M_{PDCCH}^{total,slot,μ}^{ₚ}) PDCCH candidates or more than min(s·C_{PDCCH}^{max,slot,μ}^{ₚ},C_{PDCCH,s}^{total,slot,μ}^{ₚ}) non-overlapped CCEs.

Alternatively, for the PDCCH monitoring that are configured on sSCell and schedules a transmission on PCell, the UE is not required to monitor per time unit of the sSCell, on the active DL BWP of the sSCell, more than M_{PDCCH}^{max,slot,μ}^{ₛ} PDCCH candidates or more than C_{PDCCH}^{max,slot,μ}^{ₛ} non-overlapped CCEs. Further, the UE is not required to monitor per time unit of PCell, on the active DL BWP of the sSCell, more than min(s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ},C_{PDCCH,s} ^{total,slot,μ}^{ₚ}) non-overlapped CCEs.

In another embodiment, the PCell is considered as p+s cell with SCS configuration μₚ, the total numbers of monitored PDCCH candidates and non-overlapped CCEs on PCell and sSCell do not exceed the corresponding maximum numbers of p+s cell with SCS configuration μₚ. The active DL BWP of P SCells use same numerology μₚ. The active DL BWP of S SCells use same numerology μₛ.

For the PDCCH monitoring on PCell, the maximum numbers of monitored PDCCH candidates and non-overlapped CCEs can be determined by p·M_{PDCCH}^{max,slot,μ}^{ₚ} and p·C_{PDCCH}^{max,slot,μ}^{ₚ} per time unit of PCell respectively. Further, M_{PDCCH}^{total,slot,μ}^{ₚ} and C_{PDCCH}^{total,slot,μ}^{ₚ} per time unit of PCell can be determined assuming N_{cells}^{DL,μ}^{ₚ}=P+p+s cells with same numerology μₚ as PCell and N_{cells}^{DL,μ}^{ₛ}=S cells with same numerology μₛ as sSCell. For example,
If Σ_{μ=0}^{N}^{_{μ}}N_{cells}^{DL,μ}≤N_{cells}^{cap}, the UE is not required to monitor per time unit of PCell, on the active DL BWP of the PCell, more than M_{PDCCH}^{total,slot,μ}^{ₚ}=p·M_{PDCCH}^{max,slot,μ}^{ₚ} PDCCH candidates or more than C_{PDCCH}^{total,slot,μ}^{ₚ}=p·C_{PDCCH}^{max,slot,μ}^{ₚ} non-overlapped CCEs.
If Σ_{μ=0}^{N}^{_{μ}}N_{cells}^{DL,μ>N}_{cells}^{cap}, the UE is not required to monitor per time unit of PCell, on the active DL BWP(s) of PCell, more than M_{PDCCH}^{total,slot,μ}^{ₚ}=└p·N_{cells}^{cap}·M_{PDCCH}^{max,slot,μ}^{ₚ}·N_{cells}^{DL,μ}^{ₚ}/Σⱼ₌₀^{N}^{_{μ}}N_{cells}^{DL,j}┘ PDCCH candidates or more than C_{PDCCH}^{total,slot,μ}^{ₚ}=└p·N_{cells}^{cap}·C_{PDCCH}^{max,slot,μ}^{ₚ}·N_{cells}^{DL,μ}^{ₚ}/Σⱼ₌₀^{N}^{_{μ}}N_{cells}^{DL,j}┘ non-overlapped CCEs.

Therefore, for the PDCCH monitoring on PCell, the UE is not required to monitor per time unit of PCell, on the active DL BWP of the PCell, more than min(p·M_{PDCCH}^{max,slot,μ}^{ₚ},M_{PDCCH}^{total,slot,μ}^{ₚ}) PDCCH candidates or more than min(p·C_{PDCCH}^{max,slot,μ}^{ₚ},C_{PDCCH}^{total,slot,μ}^{ₚ}) non-overlapped CCEs.

For the PDCCH monitoring that are configured on sSCell and schedules a transmission on PCell, a pair of maximum numbers of monitored PDCCH candidates and non-overlapped CCEs can be determined as by s·M_{PDCCH}^{max,slot,μ}^{ₛ} and s·C_{PDCCH}^{max,slot,μ}^{ₛ} per time unit of sSCell respectively. total,slot,ps total,slot,us per time unit on sSCell can be determined assuming Further, M_{PDCCH} and C ·PDCCH Further, M_{PDCCH}^{total,slot,μ}^{ₛ} and C_{PDCCH}^{total,slot,μ}^{ₛ} per time unit on sScell can be determined assuming Vcells N_{cells}^{DL,μ}^{ₛ}=S+s cells with same numerology μₛ as sSCell and N_{cells}^{DL,μ}^{ₚ}=P+p cells with same numerology μₚ as PCell. For example,
If Σ_{μ=0}^{N}^{_{μ}}N_{cells}^{DL,μ}≤N_{cells}^{cap}, the UE is not required to monitor per time unit on sSCell, on the active DL BWP of the sSCell, more than M_{PDCCH}^{total,slot,μ}^{ₛ}=s·M_{PDCCH}^{max,slot,μ}^{ₛ} PDCCH candidates or more than C_{PDCCH}^{total,slot,μ}^{ₛ}=s·C_{PDCCH}^{max,slot,μ}^{ₛ} non-overlapped CCEs.
If Σ_{μ=0}^{N}^{_{μ}}N_{cells}^{DL,μ}>N_{cells}^{cap}, the UE is not required to monitor per time unit of sSCell, on the active DL BWP(s) of sSCell, more than M_{PDCCH}^{total,slot,μ}^{ₛ}=└N_{cells}^{cap}·M_{PDCCH}^{max,slot,μ}^{ₛ}·N_{cells}^{DL,μ}^{ₛ}/Σⱼ₌₀^{N}^{_{μN}}_{cells}^{DL,j}┘ PDCCH candidates or more than C_{PDCCH}^{total,slot,μ}^{ₛ}=└N_{cells}^{cap}·C_{PDCCH}^{max,slot,μ}^{ₛ}·N_{cells}^{DL,μ}^{ₛ}/Σⱼ₌₀^{N}^{_{μ}}N_{cells}^{DL,j}┘ non-overlapped CCEs. Alternatively, M_{PDCCH}^{total,slot,μ}^{ₛ}=└s·N_{cells}^{cap}·M_{PDCCH}^{max,slot,μ}^{ₛ}·N_{cells}^{DL,μ}^{ₛ}/Σ_{j-32 0}^{N}^{_{μ}}N_{cells}^{DL,j}┘, C_{PDCCH}^{total,slot,μ}^{ₛ}=└s·N_{cells}^{cap}·C_{PDCCH}^{max,slot,μ}^{ₛ}·N_{cells}^{DL,μ}^{ₛ}/Σⱼ₌₀^{N}^{_{μ}}N_{cells}^{DL,j}┘.

Further, for the PDCCH monitoring that are configured on sSCell and schedules a transmission on PCell, another pair of maximum numbers of monitored PDCCH candidates and non-overlapped CCEs can be determined as s·M_{PDCCH}^{max,slot,μ}^{ₚ} and s·C_{PDCCH}^{max,slot,μ}^{ₚ} per time unit of PCell respectively. Further M_{PDCCH}^{total,slot,μ}^{ₚ} and C_{PDCCH}^{total,slot,μ}^{ₚ} per time unit of PCell can be determined assuming N_{cells}^{DL,μ}^{ₚ}=P+p+s cells with same numerology μₚ as PCell and N_{cells}^{DL,μ}^{ₛ}=S cells with same numerology μₛ as sSCell. For example,
If Σ_{μ=0}^{N}^{_{μ}}N_{cells}^{DL,μ}≤N_{cells}^{cap}, the UE is not required to monitor per time unit of PCell, on the active DL BWP of the sSCell, more than M_{PDCCH}^{total,slot,μ}^{ₚ}=s·M_{PDCCH}^{max,slot,μ}^{ₚ} PDCCH candidates or more than C_{PDCCH,s}^{total,slot,μ}^{ₚ}=s·C_{PDCCH}^{max,slot,μ}^{ₚ} non-overlapped CCEs.
If Σ_{μ=0}^{N}^{_{μ}}N_{cells}^{DL,μ}>N_{cells}^{cap}, the UE is not required to monitor per time unit of PCell, on the active DL BWP(s) of sSCell, more than M_{PDCCH,s}^{total,slot,μ}^{ₚ}=└s·N_{Cells}^{cap}·M_{PDCCH}^{maxl,slot,μ}^{ₚ}·N_{cells}^{DL,μ}^{ₚ}/Σⱼ₌₀^{N}^{_{μ}}N_{cells}^{DL,j}┘ PDCCH candidates or more than C_{PDCCH}^{total,slot,μ}^{ₚ}=└s·N_{cells}^{cap}·C_{PDCCH}^{max,slot,μ}^{ₚ}·N_{cells}^{DL,μ}^{ₚ}/Σⱼ₌₀^{N}^{_{μ}}N_{cells}^{DL,j}┘ non-overlapped CCEs.

Therefore, for the PDCCH monitoring that are configured on sSCell and schedules a transmission on PCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs. Further, the UE is not required to monitor per time unit of PCell, on the active DL BWP of the sSCell, more than min(s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ},C_{PDCCH,s}^{total,slot,μ}^{ₚ}) non-overlapped CCEs.

Alternatively, for the PDCCH monitoring that are configured on sSCell and schedules a transmission on PCell, the UE is not required to monitor per time unit of the sSCell, on the active DL BWP of the sSCell, more than min(M_{PDCCH}^{max,slot,μ}^{ₛ},M_{PDCCH}^{total,slot,μ}^{ₛ}) PDCCH candidates or more than min(C_{PDCCH}^{max,slot,μ}^{ₛ},C_{PDCCH}^{total,slot,μ}^{ₛ}) non-overlapped CCEs. Further, the UE is not required to monitor per time unit of PCell, on the active DL BWP of the sSCell, more than min(s·M_{PDCCH}^{max,slot,μ}^{ₚ}, M_{PDCCH.s}^{total,slot,μ}^{ₚ}) PDCCH candidates or more than min(s·C_{PDCCH}^{max,slot,μ}^{ₚ},C_{PDCCH,s}^{total,slot,μ}^{ₚ}) non-overlapped CCEs.

### Systems and Implementations

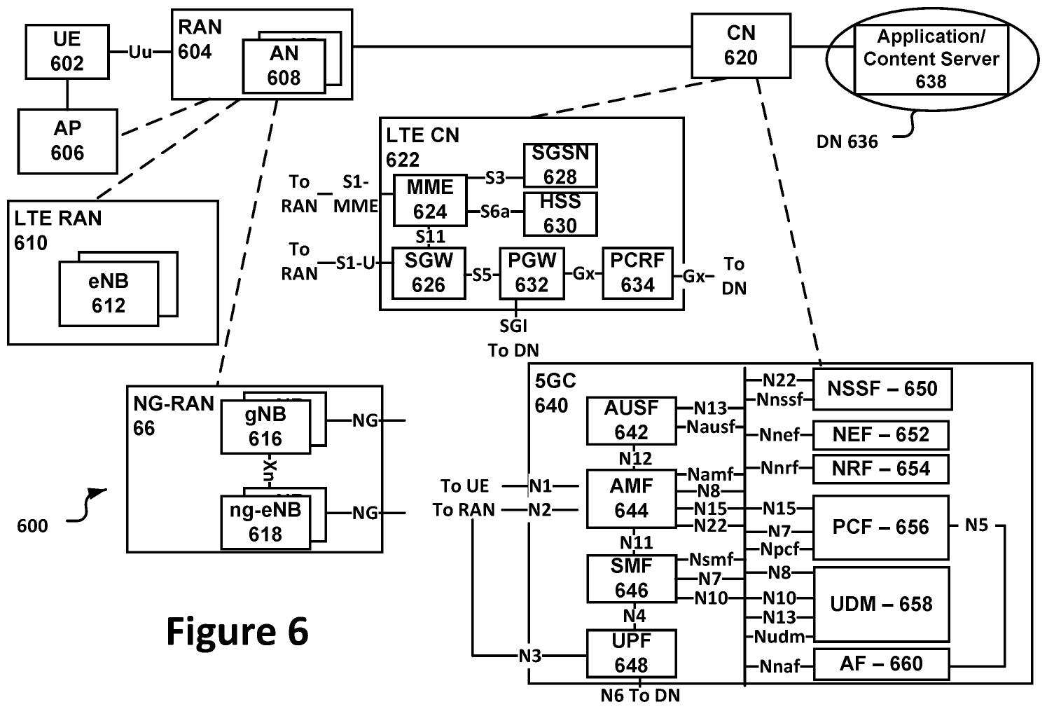

FIGS. 6-8 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and L1 protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support rt data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an S1 interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 636 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3^{rd} party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re)selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

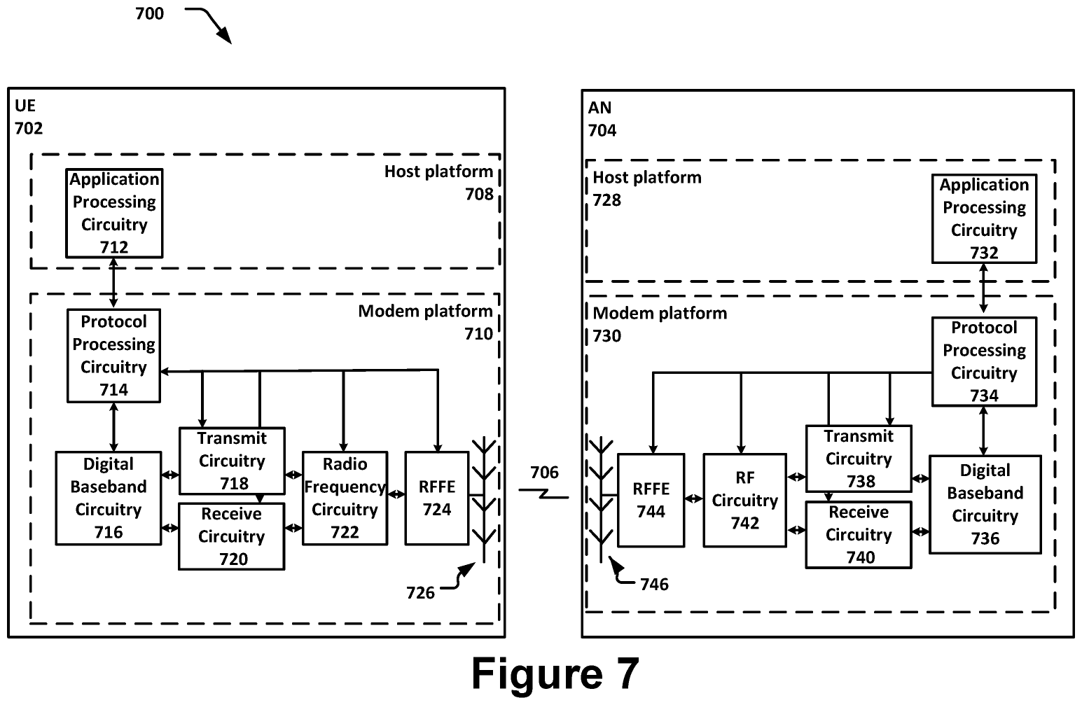

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mmWave or sub-6 GHZ frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

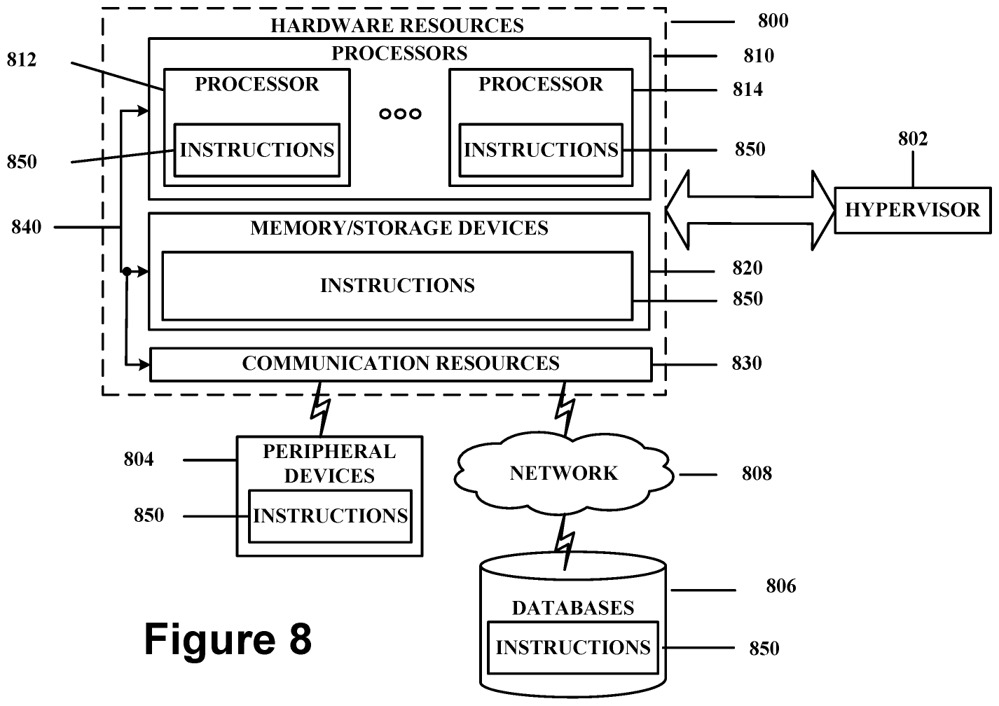

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Example Procedures

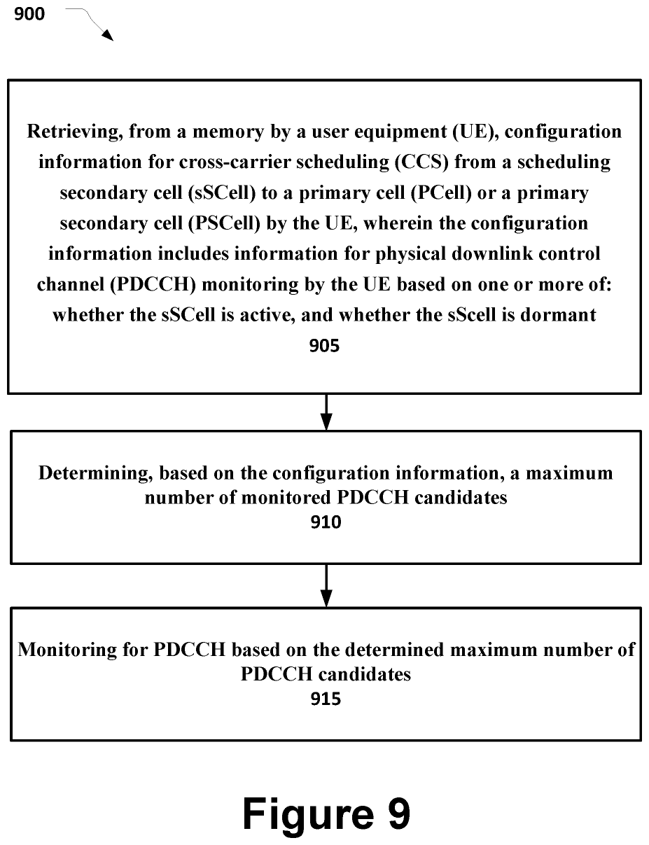

In some embodiments, the electronic device(s), network(s), system(s), chip(s) or component(s), or portions or implementations thereof, of FIGS. 6-8, or some other figure herein, may be configured to perform one or more processes, techniques, or methods as described herein, or portions thereof. One such process is depicted in FIG. 9. For example, the process 900 may include, at 905, retrieving, from a memory by a user equipment (UE), configuration information for cross-carrier scheduling (CCS) from a scheduling secondary cell (sSCell) to a primary cell (PCell) or a primary secondary cell (PSCell) by the UE, wherein the configuration information includes information for physical downlink control channel (PDCCH) monitoring by the UE based on one or more of: whether the sSCell is active, and whether the sScell is dormant. The process further includes, at 910, determining, based on the configuration information, a maximum number of monitored PDCCH candidates. The process further includes, at 915, monitoring for PDCCH based on the determined maximum number of PDCCH candidates.

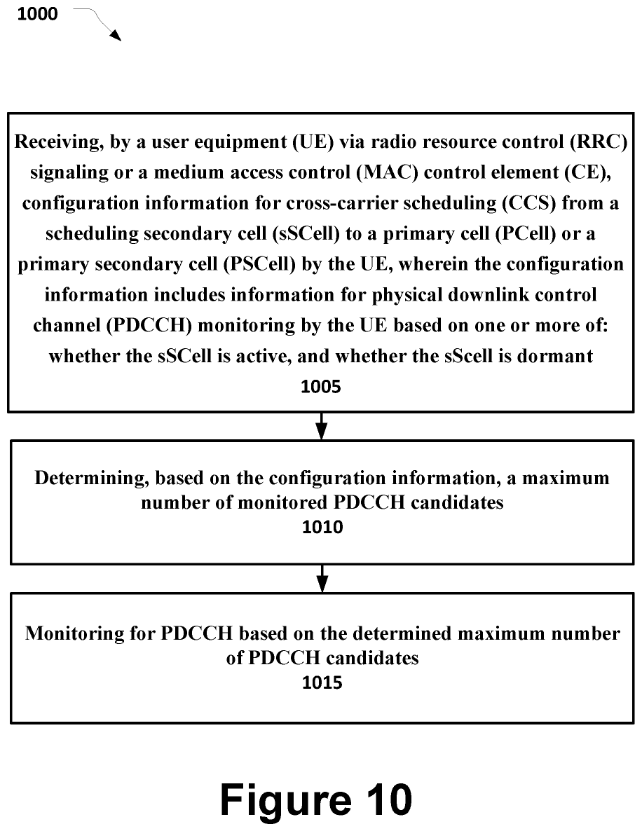

FIG. 10 illustrates another such process in accordance with various embodiments. In this example, the process 1000 includes, at 1005, receiving, by a user equipment (UE) via radio resource control (RRC) signaling or a medium access control (MAC) control element (CE), configuration information for cross-carrier scheduling (CCS) from a scheduling secondary cell (sSCell) to a primary cell (PCell) or a primary secondary cell (PSCell) by the UE, wherein the configuration information includes information for physical downlink control channel (PDCCH) monitoring by the UE based on one or more of: whether the sSCell is active, and whether the sScell is dormant. The process further includes, at 1010, determining, based on the configuration information, a maximum number of monitored PDCCH candidates. The process further includes, at 1015, monitoring for PDCCH based on the determined maximum number of PDCCH candidates.

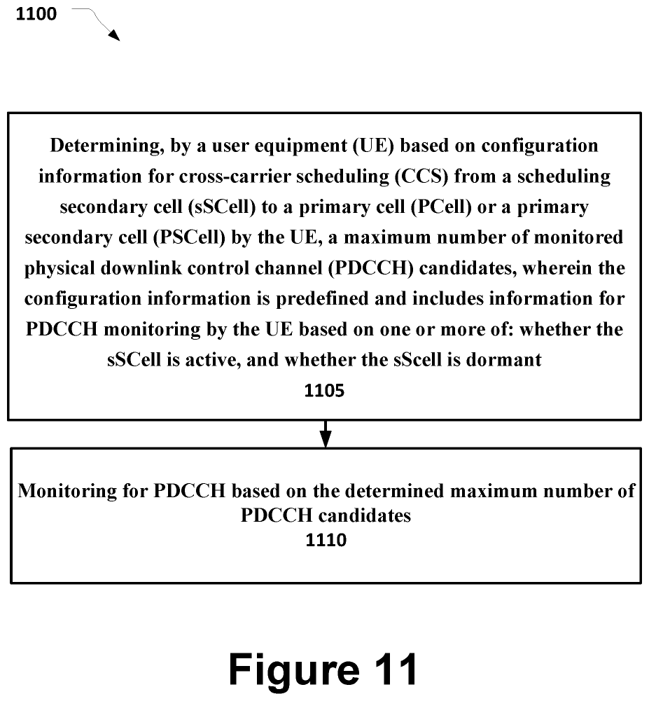

FIG. 11 illustrates another such process in accordance with various embodiments. In this example, the process 1100 includes, at 1105, determining, by a user equipment (UE) based on configuration information for cross-carrier scheduling (CCS) from a scheduling secondary cell (sSCell) to a primary cell (PCell) or a primary secondary cell (PSCell) by the UE, a maximum number of monitored physical downlink control channel (PDCCH) candidates, wherein the configuration information is predefined and includes information for PDCCH monitoring by the UE based on one or more of: whether the sSCell is active, and whether the sScell is dormant. The process further includes, at 1110, monitoring for PDCCH based on the determined maximum number of PDCCH candidates.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of wireless communication to support PDCCH monitoring considering SCell dormancy or (de)activation when cross-carrier scheduling from the SCell to PCell is configured.

Example 2 may include the method of example 1 or some other example herein, wherein scaling factors to determine maximum numbers of monitored PDCCH candidates and non-overlapped CCEs for the PDCCH monitoring on P(S)Cell and the sSCell is commonly predefined or configured.

Example 3 may include the method of example 1 or some other example herein, wherein different scaling factors are predefined or configured for the two cases that sSCell is activated or not activated, and/or for the two cases that sSCell is dormant or non-dormant.

Example 4 may include the method of example 1 or some other example herein, wherein different scaling factors are configured for the different DL BWPs of P(S)Cell, for the different DL BWPs of sSCell, or for the different combinations of DL BWPs of P(S)Cell and DL BWPs of sSCell.

Example 5 may include the method of example 4, or some other example herein, wherein common scaling factors are configured by high layer signaling for each combination of a DL BWP with SCS μₚ on P(S)Cell and a non-dormant DL BWP with SCS μₛ on sSCell, if μₚ≤μₛ.

Example 6 may include the method of example 1, wherein common scaling factors are configured by high layer signaling for each combination of a DL BWP with SCS μₚ on P(S)Cell and a non-dormant DL BWP with SCS us on sSCell, if μₚ≤μₛ and the DL BWP on the sSCell is activated and non-dormant.

Example 7 may include the method of example 1 or some other example herein, wherein the different scaling factors depends on the active search space set group (SSSG) configuration of P(S)Cell.

Example 8 may include the method of examples 1-7 or some other example herein, wherein if the sSCell is deactivated or switched to a dormant BWP, CSS from sSCell to P(S)Cell is not applicable.

Example 9 may include the method of examples 1-7 or some other example herein, wherein if P(S)Cell and/or sSCell switch to the active DL BWPs that results in larger SCS of P(S)Cell than that of sSCell, CSS from sSCell to P(S)Cell is not applicable.

Example 10 may include the method of example 1 or some other example herein, wherein an indicator is configured by high layer to configure whether UE needs to monitor a USS set on the P(S)Cell when sSCell is using a non-dormant active DL BWP.

Example 11 may include the method of example 1 or some other example herein, when the sSCell is switching between the activation state and deactivation state, the new numerology of BWP and/or new value pair (α,β), or the new SSSG configuration is applied starting from timing t which is determined by one of the following options:

$$slot n + {k}_{1} + 1 , or ,$$

$$slot n + {k}_{1} + 3 {N}_{slot}^{subframe , μ} + 1 , or$$

$$slot n + {k}_{1} + 1 + δ where slot n + {k}_{1} , or ,$$

$$slot n + {k}_{1} + 3 {N}_{slot}^{subframe , μ} + 1 + δ , or ,$$

$$slot n + 1 + \frac{{T}_{H A R Q} + {T}_{activation\_time} + {T}_{CSI\_Reporting}}{NR slot length of PUCCH} .$$

Example 12 may include the method of example 1 or some other example herein, when the sSCell is switching between the dormant BWP and a non-dormant BWP, the new numerology of BWP and/or new value pair (α,β), or the new SSSG configuration is applied starting from timing t, which is determined by one of the following options:

$$slot ⌊ n \cdot \frac{{2}^{μ} P D S C H}{{2}^{μ} P D C C H} ⌋ + {K}_{0} or slot ⌊ n \cdot \frac{{2}^{μ} P U S C H}{{2}^{μ} P D C C H} ⌋ + {K}_{2} , or$$

$$slot n + {k}_{1} + 1 , or ,$$

$$slot n + 1 + δ , or ,$$

$$slot n + 1 + max ( {k}_{1} , δ ) , or ,$$

$$slot n + {k}_{1} + 1 + δ .$$

Example 13 may include a method of a UE, the method comprising:

identifying a cross-carrier scheduling configuration in which a secondary cell (SCell) is to schedule a communication on a primary cell (PCell);

determining PDCCH monitoring occasions on the SCell based on a scaling factor; and

monitoring for a PDCCH in one or more of the PDCCH monitoring occasions.

Example 14 may include the method of example 13 or some other example herein, wherein different scaling factors are used when the SCell is dormant or non-dormant and/or activated or deactivated.

Example 15 may include the method of example 13-14 or some other example herein, wherein different scaling factors are configured for different DL BWPs of P(S)Cell, for different DL BWPs of sSCell, and/or for different combinations of DL BWPs of P(S)Cell and DL BWPs of sSCell.

Example 16 may include the method of example 13-15 or some other example herein, wherein the scaling factor depends on an active search space set group (SSSG) configuration of P(S)Cell.

Example X1 may include a method of wireless communication comprising:

receiving, by a UE, the high layer configuration on the scheduling scheme for a transmission on PCell;

detecting, by the UE, a PDCCH scheduling a transmission on PCell which is on PCell or the scheduling SCell.

Example X2 may include the method of example X1 or some other example herein, wherein in the PDCCH monitoring for PCell, the maximum numbers of monitored PDCCH candidates and non-overlapped CCEs are separately determined for the PDCCH monitoring on PCell and the PDCCH monitoring on sSCell that that schedules a transmission on PCell.

Example X3 may include the method of example X2 or some other example herein, wherein the PDCCH monitoring for PCell is determined based on a fractional number p of a cell with numerology μₚ and a fractional number s of a cell with numerology μₛ, p≤1,s≤1. The active DL BWP of P SCells use same numerology μₚ. The active DL BWP of S SCells use same numerology μₛ.

Example X4 may include the method of example X3 or some other example herein, wherein for the PDCCH monitoring that are configured on sSCell and schedules a transmission on PCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs.

Example X5 may include the method of example X4 or some other example herein, wherein the UE is not required to monitor per time unit of PCell, on the active DL BWP of the sSCell, more than s·M_{PDCCH}^{max,slot,μ}^{ₚ} PDCCH candidates or more than s·C_{PDCCH}^{max,slot,μ}^{ₚ} non-overlapped CCEs.

Example X6 may include the method of example X4 or some other example herein, wherein the UE is not required to monitor per time unit of PCell, on the active DL BWP of the sSCell, more than min (s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ},C_{PDCCH,s}^{total,slot,μ}^{ₚ}) non-overlapped CCEs.

Example X7 may include the method of example X2 or some other example herein, wherein the PDCCH monitoring for PCell is determined based on a number p+s of a cell with numerology μₚ and the number s of a cell with numerology μₛ, p≤1,s≤1.

Example X8 may include the method of example X7 or some other example herein, wherein for the PDCCH monitoring that are configured on sSCell and schedules a transmission on PCell, the UE is not required to monitor per time unit of PCell, on the active DL BWP of the sSCell, more than PDCCH candidates or more than min(s·C_{PDCCH}^{max,slot,μ}^{ₚ},C_{PDCCH.s}^{total,slot,μ}^{ₚ}) non-overlapped CCEs, assuming N_{cells}^{DL,μ}^{ₚ}=P+p+s cells with same numerology μₚ as PCell and N_{cells}^{DL,μ}^{ₛ}=S cells with same numerology μₛ as sSCell.

Example X9 may include the method of example X8 or some other example herein, wherein the UE is not required to monitor per time unit of the sSCell, on the active DL BWP of the sSCell, more than s·M_{PDCCH}^{max,slot,μ}^{ₛ} or M_{PDCCH}^{max,slot,μ}^{ₛ} PDCCH candidates or more than s·C_{PDCCH}^{max,slot,μ}^{ₛ} or C_{PDCCH}^{max,slot,μ}^{ₛ} non-overlapped CCEs.

Example X10 may include the method of example X7 or some other example herein, wherein for the PDCCH monitoring that are configured on sSCell and schedules a transmission on PCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) or min (M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) or min (C_{PDCCH}^{max,slot,μ}^{ₛ},C_{PDCCH}^{total,slot,μ}^{ₛ}) non-overlapped CCEs, assuming N_{cells}^{DL,μ}^{ₛ}=S+s cells with same numerology μₛ as sSCell and N_{cells}^{DL,μ}=P+p cells with same numerology μₚ as PCell.

Example X11 may include the method of example X10 or some other example herein, wherein the UE is not required to monitor per time unit of the sSCell, on the active DL BWP of the sSCell, more than min(s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ},C_{PDCCH,s}^{total,slot,μ}^{ₚ}) non-overlapped CCEs, assuming N_{cells}^{DL,μ}^{ₚ}=P+p+s cells with same numerology μₚ as PCell and N_{cells}^{DL,μ}^{ₛ}=S cells with same numerology μₛ as sSCell.

Example X12 may include the method of example X3 or some other example herein, wherein for the PDCCH monitoring on PCell, the UE is not required to monitor per time unit of PCell, on the active DL BWP of the PCell, more than min(p·M_{PDCCH}^{max,slot,μ}^{ₚ},M_{PDCCH}^{total,slot,μ}^{ₚ}) PDCCH candidates or more than min(p·C_{PDCCH}^{max,slot,μ}^{ₚ},M_{PDCCH}^{total,slot,μ}^{ₚ}) non-overlapped CCEs.

Example X13 may include a method of a UE, the method comprising:

receiving configuration information for scheduling of a transmission on a primary cell (PCell) by the PCell or a scheduling secondary cell (sSCell); and

monitoring for a physical downlink control channel (PDCCH) on PDCCH candidates of the PCell and the sSCell based on the configuration information.

Example X14 may include the method of example X13 or some other example herein, further comprising: receiving the PDCCH on one or more of the PDCCH candidates; and receiving the transmission on the PCell based on the PDCCH.

Example X15 may include the method of example X13-X14 or some other example herein, wherein a maximum number of monitored PDCCH candidates and non-overlapped CCEs are separately determined for the monitoring on the PCell and the monitoring on sSCell.

Example X16 may include the method of example X13-X15 or some other example herein, wherein the monitoring for the PCell is determined based on a fractional number p of a cell with numerology μₚ and/or a fractional number s of a cell with numerology μₛ, p≤1,s≤1, wherein an active DL BWP of P SCells use same numerology μₚ, and an active DL BWP of S SCells use a same numerology μₛ.

Example X17 may include the method of example X16 or some other example herein, wherein the UE is not required to monitor per time unit of PCell, on the active DL BWP of the PCell, more than min(p·M_{PDCCH}^{max,slot,μ}^{ₚ},M_{PDCCH}^{total,slot,μ}^{ₚ}) or min(M_{PDCCH}^{max,slot,μ}^{ₛ},M_{PDCCH}^{total,slot,μ}^{ₛ}) PDCCH candidates or more than min(p·C_{PDCCH}^{max,slot,μ}^{ₚ},C_{PDCCH}^{total,slot,μ}^{ₚ}) or min(C_{PDCCH}^{max,slot,μ}^{ₛ},C_{PDCCH}^{total,slot,μ}^{ₛ}) non-overlapped CCEs.

Example X18 may include the method of example X16 or some other example herein, wherein for the monitoring of the PDCCH candidates on the sSCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs. C_{PDCCH}

Example X19 may include the method of example X18 or some other example herein, wherein the UE is not required to monitor per time unit of PCell, on the active DL BWP of the sSCell, more than s·M_{PDCCH}^{max,slot,μ}^{ₚ} PDCCH candidates or more than s·C_{PDCCH}^{max,slot,μ}^{ₚ} non-overlapped CCEs.

Example X20 may include the method of example X16 or some other example herein, wherein for the monitoring on the sSCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs, or more than min(s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ},M_{PDCCH,s}^{total,slot,μ}^{ₚ}) non-overlapped CCEs.

Example X21 may include the method of example X17 or some other example herein, wherein the UE is not required to monitor per time unit of PCell, on the active DL BWP of the sSCell, more than min(s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ},C_{PDCCH.s}^{total,slot,μ}^{ₚ})non-overlapped CCEs.

Example X22 may include the method of example X15 or some other example herein, wherein the PDCCH monitoring for PCell is determined based on a number p+s of a cell with numerology μₚ and the number s of a cell with numerology μₛ, p≤1,s ≤1.

Example X23 may include the method of example X22 or some other example herein, wherein for the PDCCH monitoring that are configured on sSCell and schedules a transmission on PCell, the UE is not required to monitor per time unit of PCell, on the active DL BWP of the sSCell, more than PDCCH candidates or more than min(s·C_{PDCCH}^{max,slot,μ}^{ₚ},C_{PDCCH.s}^{total,slot,μ}^{ₚ}) non-overlapped CCEs, assuming N_{cells}^{DL,μ}^{ₚ}=P+p+s cells with same numerology μₚ as PCell and N_{cells}^{DL,μ}^{ₛ}=S cells with same numerology μₛ as sSCell.

Example X24 may include the method of example X23 or some other example herein, wherein the UE is not required to monitor per time unit of the sSCell, on the active DL BWP of the sSCell, more than s·M_{PDCCH}^{max,slot,μ}^{ₛ} or M_{PDCCH}^{max,slot,μ}^{ₛ} PDCCH candidates or more than s·C_{PDCCH}^{max,slot,μ}^{ₛ} or C_{PDCCH}^{max,slot,μ}^{ₛ}non-overlapped CCEs.

Example X25 may include the method of example X22 or some other example herein, wherein for the PDCCH monitoring that are configured on sSCell and schedules a transmission on PCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) or min(M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) or min(C_{PDCCH}^{max,slot,μ}^{ₛ},C_{PDCCH}^{total,slot,μ}^{ₛ}) non-overlapped CCEs, assuming Ncells N_{cells}^{DL,μ}^{ₛ}=S+s cells with same numerology μₛ as sSCell and N_{cells}^{DL,μ}=P+p cells with same numerology μₚ as PCell.

Example X26 may include the method of example X25 or some other example herein, wherein the UE is not required to monitor per time unit of the sSCell, on the active DL BWP of the sSCell, more than min (s·M_{PDCCH}^{max,slot,μ}^{ₚ},M_{PDCCH}^{total,slot,μ}^{ₚ}) PDCCH candidates or more than min(s·C_{PDCCH}^{max,slot,μ}^{ₚ},C_{PDCCH.s}^{total,slot,μ}^{ₚ}) non-overlapped CCEs, assuming N_{cells}^{DL,μ}^{ₚ}=P+p+s cells with same numerology μₚ as PCell and N_{cells}^{DL,μ}^{ₛ}=S cells with same numerology μₛ as sSCell.

Example X27 may include the method of example X16 or some other example herein, wherein for the PDCCH monitoring on PCell, the UE is not required to monitor per time unit of PCell, on the active DL BWP of the PCell, more than min(p·M_{PDCCH}^{max,slot,μ}^{ₚ},M_{PDCCH}^{total,slot,μ}^{ₚ}) PDCCH candidates or more than min(p·C_{PDCCH}^{max,slot,μ}^{ₚ},C_{PDCCH}^{total,slot,μ}^{ₚ}) non-overlapped CCEs.

Example X28 may include a method of a gNB, the method comprising:

determining configuration information for scheduling of a transmission to a user equipment (UE) on a primary cell (PCell) by the PCell or a scheduling secondary cell (sSCell);

determining physical downlink control channel (PDCCH) candidates on at least one of the PCell or the sSCell based on the configuration information; and

encoding the PDCCH for transmission to the UE in one or more of the PDCCH candidates.

Example X29 may include the method of example X28 or some other example herein, wherein a maximum number of monitored PDCCH candidates and non-overlapped CCEs are separately determined for the monitoring on the PCell and the monitoring on sSCell.

Example X30 may include the method of example X28-X29 or some other example herein, wherein the monitoring for the PCell is determined based on a fractional number p of a cell with numerology μₚ and/or a fractional number s of a cell with numerology μₛ, p≤1,s ≤1, wherein an active DL BWP of P SCells use same numerology μₚ, and an active DL BWP of S SCells use a same numerology μₛ.

Example X31 may include the method of example X30 or some other example herein, wherein the UE is not required to monitor per time unit of PCell, on the active DL BWP of the PCell, more than min(p·M_{PDCCH}^{max,slot,μ}^{ₚ},M_{PDCCH}^{total,slot,μ}^{ₚ}) PDCCH candidates or more than min(p·C_{PDCCH}^{max,slot,μ}^{ₚ},C_{PDCCH}^{total,slot,μ}^{ₚ}) non-overlapped CCEs.

Example X32 may include the method of example X30 or some other example herein, wherein for the monitoring of the PDCCH candidates on the sSCell, the UE is not required to monitor per time unit of the sSCell, on the active DL BWP of the sSCell, more than min(s·M_{PDCCH}^{max,slot,μ}^{ₛ},M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs.

Example X33 may include the method of example X32 or some other example herein, wherein the UE is not required to monitor per time unit of PCell, on the active DL BWP of the sSCell, more than s·M_{PDCCH}^{max,slot,μ}^{ₚ} PDCCH candidates or more than s·C_{PDCCH}^{max,slot,μ}^{ₚ} non-overlapped CCEs.

Example X34 may include the method of example X30 or some other example herein, wherein for the monitoring on the sSCell, the UE is not required to monitor per time unit of the sSCell, on the active DL BWP of the sSCell, more than min(s·M_{PDCCH}^{max,slot,μ}^{ₛ}, M_{PDCCH}^{total,slot,μ}^{ₛ}) PDCCH candidates or more than min(s·C_{PDCCH}^{max,slot,μ}^{ₛ},C_{PDCCH}^{total,slot,μ}^{ₛ}) non-overlapped CCEs, or more than min(s·M_{PDCCH}^{max,slot,μ}^{ₚ},M_{PDCCH,s}^{total,slot,μ}^{ₚ}) PDCCH candidates or more than min(s·C_{PDCCH}^{max,slot,μ}^{ₚ},C_{PDCCH,s}^{total,slot,μ}^{ₚ}) non-overlapped CCEs.

Example X35 may include the method of example X30-X34 or some other example herein, further comprising encoding the configuration information for transmission to the UE.

Example X36 may include the method of example X30-X35 or some other example herein, wherein the gNB implements the PCell.

Example X37 may include the method of example X23-X29 or some other example herein, wherein the gNB implements the sSCell.

Example Y1 includes an apparatus of a user equipment (UE) comprising:

memory to store configuration information for cross-carrier scheduling (CCS) from a scheduling secondary cell (sSCell) to a primary cell (PCell) or a primary secondary cell (PSCell) by the UE; and

processing circuitry, coupled with the memory, to:

retrieve the configuration information from the memory, wherein the configuration information includes information for physical downlink control channel (PDCCH) monitoring by the UE based on one or more of: whether the sSCell is active, and whether the sScell is dormant;

determine, based on the configuration information, a maximum number of monitored PDCCH candidates; and

monitor for PDCCH based on the determined maximum number of PDCCH candidates.

Example Y2 includes the apparatus of example Y1 or some other example herein, wherein the configuration information includes an indication of a first scaling factor (α) and a second scaling factor (β) upon which the maximum number of PDCCH candidates is determined.

Example Y3 includes the apparatus of example Y2 or some other example herein, wherein the configuration information includes a common value pair of (α,β) for each combination of a downlink (DL) bandwidth part (BWP) with a first subcarrier spacing (SCS) on the PCell or PSCell, and a non-dormant DL BWP with a second SCS on the sSCell, wherein the first SCS is less than the second SCS.

Example Y4 includes the apparatus of example Y2 or some other example herein, wherein the configuration information includes respective value pairs of (α,β) for each respective search space set group (SSSG) configuration in a plurality of SSSG configurations.

Example Y5 includes the apparatus of example Y1 or some other example herein, wherein a PDCCH monitoring capability for the PCell or PSCell is split between two scheduling cells of the PCell or PSCell and the sSCell in response to the sSCell being activated or non-dormant.

Example Y6 includes the apparatus of example Y1 or some other example herein, wherein a PDCCH monitoring capability for the PCell or PSCell is fully applied to the PCell or PSCell in response to the sSCell being deactivated or dormant.

Example Y7 includes the apparatus of example Y1 or some other example herein, wherein determining the maximum number of PDCCH candidates is based on a configured dormant bandwidth part (BWP) for the sSCell.

Example Y8 includes the apparatus of any of examples Y1-Y7 or some other example herein, wherein the configuration information includes an indication of whether UE is to monitor a UE-specific search space (USS) set on the PCell or PSCell when the sSCell is using a non-dormant active DL BWP.

Example Y9 includes the apparatus of any of examples Y1-Y8 or some other example herein, wherein the configuration information is predetermined, or received via radio resource control (RRC) signaling or a medium access control (MAC) control element (CE).

Example Y10 includes one or more computer-readable media storing instructions that, when executed by one or more processors, cause a user equipment (UE) to:

receive, via radio resource control (RRC) signaling or a medium access control (MAC) control element (CE), configuration information for cross-carrier scheduling (CCS) from a scheduling secondary cell (sSCell) to a primary cell (PCell) or a primary secondary cell (PSCell) by the UE, wherein the configuration information includes information for physical downlink control channel (PDCCH) monitoring by the UE based on one or more of: whether the sSCell is active, and whether the sScell is dormant;

determine, based on the configuration information, a maximum number of monitored PDCCH candidates; and

monitor for PDCCH based on the determined maximum number of PDCCH candidates.

Example Y11 includes the one or more computer-readable media of example Y10 or some other example herein, wherein the configuration information includes an indication of a first scaling factor (α) and a second scaling factor (β) upon which the maximum number of PDCCH candidates is determined.

Example Y12 includes the one or more computer-readable media of example Y11 or some other example herein, wherein the configuration information includes a common value pair of (α,β) for each combination of a downlink (DL) bandwidth part (BWP) with a first subcarrier spacing (SCS) on the PCell or PSCell, and a non-dormant DL BWP with a second SCS on the sSCell, wherein the first SCS is less than the second SCS.

Example Y13 includes the one or more computer-readable media of example Y11 or some other example herein, wherein the configuration information includes respective value pairs of (α,β) for each respective search space set group (SSSG) configuration in a plurality of SSSG configurations.

Example Y14 includes the one or more computer-readable media of example Y10 or some other example herein, wherein a PDCCH monitoring capability for the PCell or PSCell is split between two scheduling cells of the PCell or PSCell and the sSCell in response to the sSCell being activated or non-dormant.

Example Y15 includes the one or more computer-readable media of example Y10 or some other example herein, wherein a PDCCH monitoring capability for the PCell or PSCell is fully applied to the PCell or PSCell in response to the sSCell being deactivated or dormant.

Example Y16 includes the one or more computer-readable media of example Y10 or some other example herein, wherein determining the maximum number of PDCCH candidates is based on a configured dormant bandwidth part (BWP) for the sSCell.

Example Y17 includes the one or more computer-readable media of any of examples Y10-Y16 or some other example herein, wherein the configuration information includes an indication of whether UE is to monitor a UE-specific search space (USS) set on the PCell or PSCell when the sSCell is using a non-dormant active DL BWP.

Example Y18 includes one or more computer-readable media storing instructions that, when executed by one or more processors, cause a user equipment (UE) to:

determine, based on configuration information for cross-carrier scheduling (CCS) from a scheduling secondary cell (sSCell) to a primary cell (PCell) or a primary secondary cell (PSCell) by the UE, a maximum number of monitored physical downlink control channel (PDCCH) candidates, wherein the configuration information is predefined and includes information for PDCCH monitoring by the UE based on one or more of: whether the sSCell is active, and whether the sScell is dormant; and

monitor for PDCCH based on the determined maximum number of PDCCH candidates.

Example Y19 includes the one or more computer-readable media of example Y18 or some other example herein, wherein the configuration information includes an indication of a first scaling factor (α) and a second scaling factor (β) upon which the maximum number of PDCCH candidates is determined.

Example Y20 includes the one or more computer-readable media of example Y19 or some other example herein, wherein the configuration information includes:

a common value pair of (α,β) for each combination of a downlink (DL) bandwidth part (BWP) with a first subcarrier spacing (SCS) on the PCell or PSCell, and a non-dormant DL BWP with a second SCS on the sSCell, wherein the first SCS is less than the second SCS; or

respective value pairs of (α,β) for each respective search space set group (SSSG) configuration in a plurality of SSSG configurations.

Example Y21 includes the one or more computer-readable media of example Y18 or some other example herein, wherein a PDCCH monitoring capability for the PCell or PSCell is split between two scheduling cells of the PCell or PSCell and the sSCell in response to the sSCell being activated or non-dormant.

Example Y22 includes the one or more computer-readable media of example Y18 or some other example herein, wherein a PDCCH monitoring capability for the PCell or PSCell is fully applied to the PCell or PSCell in response to the sSCell being deactivated or dormant.

Example Y23 includes the one or more computer-readable media of example Y18 or some other example herein, wherein determining the maximum number of PDCCH candidates is based on a configured dormant bandwidth part (BWP) for the sSCell.

Example Y24 includes the one or more computer-readable media of any of examples Y18-Y23 or some other example herein, wherein the configuration information includes an indication of whether UE is to monitor a UE-specific search space (USS) set on the PCell or PSCell when the sSCell is using a non-dormant active DL BWP.

Example Z01 may include an apparatus comprising means to perform one or more elements of a method described in or related to any of examples 1-Y24, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-Y24, or any other method or process described herein.

Example Z03 may include an apparatus comprising logic, modules, or circuitry to perform one or more elements of a method described in or related to any of examples 1-Y24, or any other method or process described herein.

Example Z04 may include a method, technique, or process as described in or related to any of examples 1-Y24, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-Y24, or portions thereof.

Example Z06 may include a signal as described in or related to any of examples 1-Y24, or portions or parts thereof.

Example Z07 may include a datagram, packet, frame, segment, protocol data unit (PDU), or message as described in or related to any of examples 1-Y24, or portions or parts thereof, or otherwise described in the present disclosure.

Example Z08 may include a signal encoded with data as described in or related to any of examples 1-Y24, or portions or parts thereof, or otherwise described in the present disclosure.

Example Z09 may include a signal encoded with a datagram, packet, frame, segment, protocol data unit (PDU), or message as described in or related to any of examples 1-Y24, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-Y24, or portions thereof.

Example Z11 may include a computer program comprising instructions, wherein execution of the program by a processing element is to cause the processing element to carry out the method, techniques, or process as described in or related to any of examples 1-Y24, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTCmassive | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time Rx Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | SS/PBCH Block Resource Indicator, Synchronization |
| Block SSBRI | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, VLAN Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-24. (canceled)

25. An apparatus of a user equipment (UE) comprising:
memory to store configuration information for cross-carrier scheduling (CCS) from a scheduling secondary cell (sSCell) to a primary cell (PCell) or a primary secondary cell (PSCell) by the UE; and
processor circuitry, coupled with the memory, to:
retrieve the configuration information from the memory, wherein the configuration information includes information for physical downlink control channel (PDCCH) monitoring by the UE based on one or more of: whether the sSCell is active, and whether the sScell is dormant;
determine, based on the configuration information, a maximum number of monitored PDCCH candidates; and
monitor for PDCCH based on the determined maximum number of PDCCH candidates.

26. The apparatus of claim 25, wherein the configuration information includes an indication of a first scaling factor (α) and a second scaling factor (β) upon which the maximum number of PDCCH candidates is determined.

27. The apparatus of claim 26, wherein the configuration information includes a common value pair of (α,β) for each combination of a downlink (DL) bandwidth part (BWP) with a first subcarrier spacing (SCS) on the PCell or PSCell, and a non-dormant DL BWP with a second SCS on the sSCell, wherein the first SCS is less than the second SCS.

28. The apparatus of claim 26, wherein the configuration information includes respective value pairs of (α,β) for each respective search space set group (SSSG) configuration in a plurality of SSSG configurations.

29. The apparatus of claim 25, wherein a PDCCH monitoring capability for the PCell or PSCell is split between two scheduling cells of the PCell or PSCell and the sSCell in response to the sSCell being activated or non-dormant.

30. The apparatus of claim 25, wherein a PDCCH monitoring capability for the PCell or PSCell is fully applied to the PCell or PSCell in response to the sSCell being deactivated or dormant.

31. The apparatus of claim 25, wherein the determination of the maximum number of PDCCH candidates is based on a configured dormant bandwidth part (BWP) for the sSCell.

32. The apparatus of claim 25, wherein the configuration information includes an indication of whether the UE is to monitor a UE-specific search space (USS) set on the PCell or PSCell when the sSCell is using a non-dormant active DL BWP.

33. The apparatus of claim 25, wherein the configuration information is predetermined, or received via radio resource control (RRC) signaling or a medium access control (MAC) control element (CE).

34. One or more non-transitory computer-readable media storing instructions that, when executed by one or more processors, cause a user equipment (UE) to:
receive, via radio resource control (RRC) signaling or a medium access control (MAC) control element (CE), configuration information for cross-carrier scheduling (CCS) from a scheduling secondary cell (sSCell) to a primary cell (PCell) or a primary secondary cell (PSCell) by the UE, wherein the configuration information includes information for physical downlink control channel (PDCCH) monitoring by the UE based on one or more of: whether the sSCell is active, and whether the sScell is dormant;
determine, based on the configuration information, a maximum number of monitored PDCCH candidates; and
monitor for PDCCH based on the determined maximum number of PDCCH candidates.

35. The one or more non-transitory computer-readable media of claim 34, wherein the configuration information includes an indication of a first scaling factor (α) and a second scaling factor (β) upon which the maximum number of PDCCH candidates is determined.

36. The one or more non-transitory computer-readable media of claim 35,
wherein the configuration information includes a common value pair of (α,β) for each combination of a downlink (DL) bandwidth part (BWP) with a first subcarrier spacing (SCS) on the PCell or PSCell, and a non-dormant DL BWP with a second SCS on the sSCell, wherein the first SCS is less than the second SCS; or
wherein the configuration information includes respective value pairs of (α,β) for each respective search space set group (SSSG) configuration in a plurality of SSSG configurations.

37. The one or more non-transitory computer-readable media of claim 34,
wherein a PDCCH monitoring capability for the PCell or PSCell is split between two scheduling cells of the PCell or PSCell and the sSCell in response to the sSCell being activated or non-dormant; or
wherein a PDCCH monitoring capability for the PCell or PSCell is fully applied to the PCell or PSCell in response to the sSCell being deactivated or dormant.

38. The one or more non-transitory computer-readable media of claim 34, wherein the determination of the maximum number of PDCCH candidates is based on a configured dormant bandwidth part (BWP) for the sSCell.

39. The one or more non-transitory computer-readable media of claim 34, wherein the configuration information includes an indication of whether the UE is to monitor a UE-specific search space (USS) set on the PCell or PSCell when the sSCell is using a non-dormant active DL BWP.

40. One or more non-transitory computer-readable media storing instructions that, when executed by one or more processors, cause a user equipment (UE) to:
determine, based on configuration information for cross-carrier scheduling (CCS) from a scheduling secondary cell (sSCell) to a primary cell (PCell) or a primary secondary cell (PSCell) by the UE, a maximum number of monitored physical downlink control channel (PDCCH) candidates, wherein the configuration information is predefined and includes information for PDCCH monitoring by the UE based on one or more of: whether the sSCell is active, and whether the sScell is dormant; and
monitor for PDCCH based on the determined maximum number of PDCCH candidates.

41. The one or more non-transitory computer-readable media of claim 40, wherein the configuration information includes an indication of a first scaling factor (α) and a second scaling factor (β) upon which the maximum number of PDCCH candidates is determined.

42. The one or more non-transitory computer-readable media of claim 41, wherein the configuration information includes:
a common value pair of (α,β) for each combination of a downlink (DL) bandwidth part (BWP) with a first subcarrier spacing (SCS) on the PCell or PSCell, and a non-dormant DL BWP with a second SCS on the sSCell, wherein the first SCS is less than the second SCS; or
respective value pairs of (α,β) for each respective search space set group (SSSG) configuration in a plurality of SSSG configurations.

43. The one or more non-transitory computer-readable media of claim 40,
wherein a PDCCH monitoring capability for the PCell or PSCell is split between two scheduling cells of the PCell or PSCell and the sSCell in response to the sSCell being activated or non-dormant; or
wherein a PDCCH monitoring capability for the PCell or PSCell is fully applied to the PCell or PSCell in response to the sSCell being deactivated or dormant.

44. The one or more non-transitory computer-readable media of claim 40, wherein the determination of the maximum number of PDCCH candidates is based on a configured dormant bandwidth part (BWP) for the sSCell; and
wherein the configuration information includes an indication of whether the UE is to monitor a UE-specific search space (USS) set on the PCell or PSCell when the sSCell is using a non-dormant active DL BWP.
